(19) United States
(12) Patent Application Publication
(10) Pub. No.: US 2010/0287710 A1
(43) Pub. Date: Nov. 18, 2010

(54) PERFUME SYSTEMS

(76) Inventors: Hugo Robert Germain Denutte, Hofstade (Aalst) (BE); Philip Andrew Cunningham, Vossem (BE); An Pintens, Brasschaat (BE); David Thomas Stanton, Hamilton, OH (US); Sofie Eduard Hilda Van De Velde, Stekene (BE); Marc Odilon V. Van De Walle, Scheldewindeke (BE); Stéphane Camille D. Peeters, Dion-le-Mont (BE); Johan Smets, Lubbeek (BE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/779,977

(22) Filed: May 14, 2010

Related U.S. Application Data
(60) Provisional application No. 61/178,530, filed on May 15, 2009.

(51) Int. Cl. C11D 3/37; C11D 17/08; C11D 3/50; D06L 1/08

(52) U.S. Cl. 8/137; 510/337; 510/356; 512/4; 8/142

(57) ABSTRACT

The present application relates to polymer assisted perfume delivery systems and consumer products comprising such perfume delivery systems, as well as processes for making and using such perfume delivery systems and consumer products. The delivery systems, disclosed herein expand the perfume communities' options as such delivery systems can provide variations on character and desired odor profiles.

### CROSS-REFERENCE TO RELATED APPLICATIONS

This application claims priority under 35 USC §119(e) to U.S. Provisional Application Ser. No. 61/178,530, filed May 15, 2009.

### FIELD OF INVENTION

The present application relates to polymer assisted perfume delivery systems, for example, core shell systems and consumer products comprising such perfume delivery systems, as well as processes for making and using such perfume delivery systems and consumer products.

### BACKGROUND OF THE INVENTION

Consumer products may comprise one or more perfumes and/or perfume delivery systems that can provide a desired scent to such product and/or a situs that is contacted with such a product and/or mask an undesirable odor. While current perfumes and perfume delivery systems provide desirable odors, consumers continue to seek products that have scents that may be longer lasting and that are tailored to their individual desires (see for example USPA 2007/0275866 A1 and U.S. patent application Ser. No. 12/133,866)—unfortunately when perfume microcapsules are employed such capsule do not have the desired perfume delivery characteristics as the perfume diffuses and/or leaks from the capsule at the wrong time.

Applicants recognized that if certain perfumes are employed with certain perfume microcapsule wall structures, an improved perfume delivery profile can be obtained. While not being bound by theory, Applicants believe that the perfumes in the perfume microcapsules disclosed herein diffuse and/or leak in dry environments, including but not limited to dried garments, hair, skin, but do not diffuse and/or leak in liquid environments such as liquid consumer products including but not limited to, laundry and/or personal care products. Thus, the perfume tends to not leak from the perfume microcapsules while in product, but instead, the perfume leaves the perfume microcapsule after such capsule is applied to the situs that is treated with the perfume microcapsule containing product.

### SUMMARY OF THE INVENTION

The present application relates to polymer assisted perfume delivery systems, for example, core shell systems and consumer products comprising such perfume delivery systems, as well as processes for making and using such perfume delivery systems and consumer products.

### DETAILED DESCRIPTION OF THE INVENTION

### Definitions

As used herein “consumer product” means baby care, beauty care, fabric & home care, family care, feminine care, health care, snack and/or beverage products or devices generally intended to be used or consumed in the form in which it is sold. Such products include but are not limited to diapers, bibs, wipes; products for and/or methods relating to treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use including fine fragrances; and shaving products, products for and/or methods relating to treating fabrics, hard surfaces and any other surfaces in the area of fabric and home care, including: air care including air fresheners and scent delivery systems, car care, dishwashing, fabric conditioning (including softening and/or freshing), laundry detergency, laundry and rinse additive and/or care, hard surface cleaning and/or treatment including floor and toilet bowl cleaners, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, RX pharmaceuticals, pet health and nutrition; processed food products intended primarily for consumption between customary meals or as a meal accompaniment (non-limiting examples include potato chips, tortilla chips, popcorn, pretzels, corn chips, cereal bars, vegetable chips or crisps, snack mixes, party mixes, multigrain chips, snack crackers, cheese snacks, pork rinds, corn snacks, pellet snacks, extruded snacks and bagel chips); and coffee.

As used herein, the term “cleaning and/or treatment composition” is a subset of consumer products that includes, unless otherwise indicated, beauty care, fabric & home care products. Such products include, but are not limited to, products for treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use including fine fragrances; and shaving products, products for treating fabrics, hard surfaces and any other surfaces in the area of fabric and home care, including: air care including air fresheners and scent delivery systems, car care, dishwashing, fabric conditioning (including softening and/or freshing), laundry detergency, laundry and rinse additive and/or care, hard surface cleaning and/or treatment including floor and toilet bowl cleaners, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, dentifrice, car or carpet shampoos, bathroom cleaners including toilet bowl cleaners; hair shampoos and hair-rinses; shower gels, fine fragrances and foam baths and metal cleaners; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists all for consumer or/and institutional use; and/or methods relating to oral care including toothpastes, tooth gels, tooth rinses, denture adhesives, tooth whitening.

As used herein, the term “fabric and/or hard surface cleaning and/or treatment composition” is a subset of cleaning and treatment compositions that includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, car or carpet shampoos, bathroom cleaners including toilet bowl cleaners; and metal cleaners, fabric conditioning products including softening and/or freshing that may be in liquid, solid and/or dryer sheet form ; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists. All of such products may be in standard, concentrated or even highly concentrated form even to the extent that such products may in certain aspect be non-aqueous.

As used herein, articles such as “a” and “an” when used in a claim, are understood to mean one or more of what is claimed or described.

As used herein, the terms “include”, “includes” and “including” are meant to be non-limiting.

As used herein, the term “solid” includes granular, powder, bar and tablet product forms.

As used herein, the term “fluid” includes liquid, gel, paste and gas product forms.

As used herein, the term “situs” includes paper products, fabrics, garments, hard surfaces, hair and skin.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Consumer Products

Applicants recognized that the Table 1 materials and the stereoisomers thereof diffuse and/or leak surprisingly slowly through the capsule wall when such capsules are in a consumer product, for example a cleaning and/or treatment composition. Yet, after such capsules are delivered by such product to a situs, such as a fabric, a hard surface, skin or hair, such capsules release perfume in a desired manner. Such release profile can be measured by the Headspace Ratio Method and Benefit Agent Leakage Method contained in the present specification.

TABLE 1
Suitable Perfume Raw Materials (“PRMs”)

| Item No. | Common Name | IUPAC Name (Chemical Name) |
|---|---|---|
| 1 | (+)-D-menthyl | (5-methyl-2-propan-2-ylcyclohexyl) acetate |
| | acetate | |
| 2 | (I)-citronellal | 3,7-dimethyloct-6-en-1-al |
| 3 | 2-phenoxyethyl | 2-(phenoxy)ethyl 2-methylpropanoate |
| | isobutyrate | |
| 4 | allyl amyl | prop-2-enyl 2-(3-methylbutoxy)acetate |
| | glycolate | |
| 5 | alicate | 3-methyl-1-isobutylbutyl acetate |
| 6 | allyl caproate | prop-2-enyl hexanoate |
| 7 | allyl cyclohexyl | prop-2-enyl 3-cyclohexylpropanoate |
| | propionate | |
| 8 | allyl heptanoate | prop-2-enyl heptanoate |
| 9 | alpha damascone | (E)-1-(2,6,6-trimethyl-1-cyclohex-2-enyl)but-2-en-1-one |
| 10 | alpha Ionone | (E)-4-(2,6,6-trimethyl-1-cyclohex-2-enyl)but-3-en-2-one |
| 11 | alpha | (E)-3-methyl-4-(2,6,6-trimethyl-1-cyclohex-2-enyl)but-3- |
| | isomethylionone | en-2-one |
| 12 | alpha methyl | 1-(2,6,6-trimethyl-1-cyclohex-2-enyl)pent-1-en-3-one |
| | ionone | |
| 13 | ambrox | 6,6,9a-trimethyl-1,2,3a,4,5,5a,7,8,9,9b- |
| | | decahydronaphtho[2,1-b]furan |
| 14 | amyl salicylate | pentyl 2-hydroxybenzoate |
| 15 | beta pinene | 7,7-dimethyl-2-methylidene-norbornane |
| 16 | beta-damascone | (E)-1-(2,6,6-trimethyl-1-cyclohexenyl)but-2-en-1-one |
| 17 | beta-ionone | (E)-4-(2,6,6-trimethyl-1-cyclohexenyl)but-3-en-2-one |
| 18 | boisiris | 4-ethoxy-4,8,8-trimethyl-9- |
| | | methylidenebicyclo[3.3.1]nonane |
| 19 | bornyl acetate | (1,7,7-trimethyl-6-bicyclo[2.2.1]heptanyl) acetate |
| 20 | bourgeonal | 3-(4-tert-butylphenyl)propanal |
| 21 | cashmeran | 1,1,2,3,3-pentamethyl-2,5,6,7-tetrahydroinden-4-one |
| 22 | cassifix | 2- |
| | | oxabicyclo2.2.2octane,1methyl4(2,2,3trimethylcyclopentyl) |
| 23 | cis-3-hexenyl | [(Z)-hex-3-enyl] acetate |
| | acetate | |
| 24 | cis-3-hexenyl | [(Z)-hex-3-enyl] 2-methylbutanoate |
| | methyl butyrate | |
| 25 | cis-3-hexenyl | cis-3-hexenyl 2-hydroxybenzoate |
| | salicylate | |
| 26 | citral | 3,7-dimethylocta-2,6-dienal |
| 27 | citronellal | 3,7-dimethyloct-6-en-1-al |
| 28 | citronellol | 3,7-dimethyl-6-octen-1-ol |
| 29 | citronellyl acetate | 3,7-dimethyloct-6-enyl acetate |
| 30 | citronellyl nitrile | 3,7-dimethyloct-6-enenitrile |
| 31 | citronellyl | 2-(3,7-dimethyloct-6-enoxy)acetaldehyde |
| | oxyacetaldehyde | |
| 32 | clarycet | tetrahydro-4-methyl-2-propyl-2h-pyran-4-yl acetate |
| 33 | coranol | ethyl 3-phenyloxirane-2-carboxylate |
| 34 | cyclabute | hexahydro-4,7-methano-indenyl isobutyrate |
| 35 | cyclal C | 2,4-dimethylcyclohex-3-ene-1-carbaldehyde |
| 36 | cyclaprop | hexahydro-4,7-methano-indenyl propionate |
| 37 | cyclohexylethyl | 2-cyclohexylethyl acetate |
| | acetate | |
| 38 | cyclopentol | 2-pentylcyclopentan-1-ol |
| 39 | cymal | (2R,3R,4S,5S,6R)-2-[(2R,3S,4R,5R,6R)-6-(6- |
| | | cyclohexylhexoxy)-4,5-dihydroxy-2- |
| | | (hydroxymethyl)oxan-3-yl]oxy-6-(hydroxymethyl)oxane- |
| | | 3,4,5-triol |
| 40 | damascenone | (E)-1-(2,6,6-trimethyl-1-cyclohexa-1,3-dienyl)but-2-en-1- |
| | | one |
| 41 | datilat | 1-cyclohexylethyl (E)-but-2-enoate |
| 42 | decyl aldehyde | decanal |
| 43 | delta damascone | (E)-1-(2,6,6-trimethyl-1-cyclohex-3-enyl)but-2-en-1-one |
| 44 | delta muscenone | (5E)-3-methylcyclopentadec-5-en-1-one |
| 45 | dihydro-alpha- | 4-(2,6,6-trimethyl-1-cyclohex-2-enyl)butan-2-one |
| | ionone | |
| 46 | dihydroeugenol | 2-methoxy-4-propylphenol |
| 47 | dihydroisojasmonate | methyl 2-hexyl-3-oxocyclopentane-1-carboxylate |
| 48 | dihydromyrcenol | 2,6-dimethyloct-7-en-2-ol |
| 49 | dimethyl octenone | 4,7-dimethyloct-6-en-3-one |
| 50 | dupical | 4-(octahydro-4,7-methano-5H-inden-5-yliden)butanal |
| 51 | elintaal | acetaldehyde ethyl linalyl acetal |
| 52 | ethyl 3,7- | ethyl 3,7-dimethyl-2,6-octadienoate |
| | dimethyl-2,6- | |
| | octadienoate | |
| 53 | ethyl beta- | ethyl 2,6,6-trimethylcyclohexa-1,3-diene-1-carboxylate |
| | safranate | |
| 54 | ethyl hexanoate | 2-ethylhexanoate |
| 55 | ethyl linalool | (6E)-3,7-dimethylnona-1,6-dien-3-ol |
| 56 | ethyl methyl | ethyl 2-methylbutanoate |
| | butyrate | |
| 57 | ethyl methyl | ethyl 2-methylpentanoate |
| | pentanoate | |
| 58 | ethyl myristate | ethyl tetradecanoate |
| 59 | ethyl nonanoate | ethyl nonanoate |
| 60 | ethyl-3- | ethyl 3-phenyloxirane-2-carboxylate |
| | phenylglycidate | |
| 61 | ethylene brassylate | 1,4-dioxacycloheptadecane-5,17-dione |
| 62 | eucalyptol | 1,3,3-trimethyl-2-oxabicyclo[2,2,2]octane |
| 63 | eucalyptus | [essential oil] |
| 64 | exaltolide | oxacyclo-hexadecan-2-one |
| 65 | floralozone | 3-(4-ethylphenyl)-2,2-dimethylpropanal |
| 66 | freskomenthe | 2-butan-2-ylcyclohexan-1-one |
| 67 | fructalate | 1,4-cyclohexandicarboxylic acid, diethyl ester |
| 68 | fruitate | (3aalpha,4beta,7beta,7aalpha)-octahydro-4,7-methano- |
| | | 3aH-indene-3a-carboxylic acid ethyl ester |
| 69 | frutene | hexahydro-4-7, menthano-1H-inden-6-yl propionate |
| 70 | gamma damascone | 2-butenon-1-one,1-(2,6-dimethyl-6-methylencyclohexyl)- |
| 71 | gamma ionone | (E)-4-(2,2-dimethyl-6-methylidenecyclohexyl)but-3-en-2- |
| | | one |
| 72 | gamma terpinene | 1-methyl-4-propan-2-ylcyclohexa-1,4-diene |
| 73 | gamma | 5-heptyloxolan-2-one |
| | undecalactone | |
| 74 | geraniol | 3,7-dimethylocta-2,6-dien-1-ol |
| 75 | geranyl acetate | [(2E)-3,7-dimethylocta-2,6-dienyl] acetate |
| 76 | geranyl caprylate | [(2E)-3,7-dimethylocta-2,6-dienyl] octanoate |
| 77 | givescone | ethyl 2-ethyl-6,6-dimethylcyclohex-2-ene-1-carboxylate |
| 78 | g-terpineol acetate | (4-methyl-1-propan-2-yl-1-cyclohex-2-enyl) acetate |
| 79 | gyrane | 2-butyl-4,6-dimethyl-5,6-dihydro-2H-pyran |
| 80 | habanolide | oxacyclohexadecen-2-one |
| 81 | helvetolide | 1-propanol,2-[1-(3,3-dimethyl-cyclohexyl)ethoxy]-2- |
| | | methyl-propanoate |
| 82 | heptyl acetate | 1-heptyl acetate |
| 83 | hexyl acetate | 1-hexyl acetate |
| 84 | hexyl isobutyrate | hexyl 2-methylpropanoate |
| 85 | hyacinth body | (2-(1-ethoxyethoxy)ethyl)benzene |
| 86 | indoflor | 4,4a,5,9b-tetrahydroindeno[1,2-d][1,3]dioxine |
| 87 | intreleven | undec-10-enal |
| | aldehyde | |
| 88 | ionone gamma | 3-methyl-4-(2,6,6-trimethyl-2-cyclohexen-1-yl)-3-buten- |
| | methyl | 2-one |
| 89 | iso E super | 1-(1,2,3,4,5,6,7,8-octahydro-2,3,8,8-tetramethyl-2- |
| | | naphthalenyl)-ethan-1-one |
| 90 | iso gamma super | 7-acetyl,1,2,3,4,5,6,7-octahydro-1,1,6,7,-tetra methyl |
| | | naphtalene |
| 91 | isoamyl salicylate | 3-methylbutyl 2-hydroxybenzoate |
| 92 | isobornyl acetate | [(1R,4S,6R)-1,7,7-trimethyl-6-bicyclo[2.2.1]heptanyl]acetate |
| 93 | isobornyl | [(1R,4R,6R)-1,7,7-trimethyl-6-bicyclo[2.2.1]heptanyl] 2- |
| | isobutyrate | methylpropanoate |
| | (abierate cn) | |
| 94 | isobornyl | (1,7,7-trimethyl-5-bicyclo[2.2.1]heptanyl) propanoate |
| | propionate | |
| 95 | isobutyl caproate | 2-methylpropyl hexanoate |
| 96 | isoeugenyl acetate | [2-methoxy-4-[(E)-prop-1-enyl]phenyl] acetate |
| 97 | isojasmone | 2-hexylcyclopent-2-en-1-one |
| 98 | isomenthone | 5-methyl-2-propan-2-ylcyclohexan-1-one |
| 99 | isononyl acetate | 7-methyloctyl acetate |
| 100 | isopropyl-2- | propan-2-yl 2-methylbutanoate |
| | methylbutyrate | |
| 101 | koavone | 3,4,5,6,6-pentamethylheptenone-2 |
| 102 | koumalactone | hexahydro-3,6-dimethyl-2(3H)-benzofuranone |
| 103 | labienoxime | 2,4,4,7-tetramethyl-6,8-nonadiene-3-one oxime |
| 104 | lauryl acetate | dodecyl acetate |
| 105 | lavandin | [essential oil] |
| 106 | lemonile | 3,7-dimethylnona-2,6-dienenitrile |
| 107 | liffarome | [(Z)-hex-3-enyl] methyl carbonate |
| 108 | lilial | 2-methyl-3-(4-tert-butylphenyl)propanal |
| 109 | linalool | 3,7-dimethylocta-1,6-dien-3-ol |
| 110 | linalyl acetate | 3,7-dimethylocta-1,6-dien-3-yl acetate |
| 111 | linalyl butyrate | 3,7-dimethylocta-1,6-dien-3-yl butanoate |
| 112 | linalyl formate | 3,7-dimethylocta-1,6-dien-3-yl formate |
| 113 | linalyl isobutyrate | 3,7-dimethylocta-1,6-dien-3-yl 2-methylpropanoate |
| 114 | linalyl propionate | 3,7-dimethylocta-1,6-dien-3-yl propanoate |
| 115 | maceal | 3-methyl-7-propan-2-ylbicyclo[2.2.2]oct-2-ene-5- |
| | | carbaldehyde |
| 116 | majantol | 2,2-dimethyl-3-(3-methylphenyl)propan-1-ol |
| 117 | mefloral | 3-(4-tert-butylphenyl)butanal |
| 118 | melonal | 2,6-dimethylhept-5-enal |
| 119 | menthol | 5-methyl-2-propan-2-yl-cyclohexan-1-ol |
| 120 | methyl beta | 1-(2,6,6-trimethyl-1-cyclohexenyl)pent-1-en-3-one |
| | ionone | |
| 121 | methyl | methyl 3-oxo-2-pentylcyclopentaneacetate |
| | dihydrojasmonate | |
| 122 | methyl myristate | methyl tetradecanoate |
| 123 | methyl nonyl | 2-methylundecanal |
| | acetaldehyde | |
| 124 | methyl octyl | 2-methyldecanal |
| | acetaldehyde | |
| 125 | methyl | 1,1-dimethoxy-2,2,5-trimethyl-4-hexene |
| | pamplemousse | |
| 126 | myraldyl acetate | [(1S)-3-(4-methylpent-3-enyl)-1-cyclohex-3-enyl]methyl |
| | | acetate |
| 127 | nectaryl | 2-(2-(4-methyl-3-cyclohexen-1-yl)propyl)cyclo- |
| | | pentanone |
| 128 | neobutenone | 4-penten-1-one, 1-(5,5-dimethyl-1-cyclohexen-1-yl |
| 129 | neohivernal | 1H-indene-ar-propanal,2,3,-dihydro-1,1-dimethyl-(9CI) |
| 130 | nerolin | 2-ethoxynaphthalene |
| 131 | nonyl aldehyde | nonanal |
| 132 | nopyl acetate | 2-(7,7-dimethyl-4-bicyclo[3.1.1]hept-3-enyl)ethyl acetate |
| 133 | octyl aldehyde | octanal |
| 134 | orange flower | 4-(1-methoxy-1-methylethyl)-1-methylcyclohexene |
| | ether | |
| 135 | o-tert- | (2-tert-butylcyclohexyl) acetate |
| | butylcyclohexyl | |
| | acetate | |
| 136 | ozofleur | (E)-1-ethoxy-4-(2-methylbutan-2-yl)cyclohexane |
| 137 | parmavert | 1,1-dimethoxynon-2-yne |
| 138 | patchouli | [essential oil] |
| 139 | peonile | 2-cyclohexylidene-2-phenylacetonitrile |
| 140 | pharaone | 2-cyclohexyl-1,6-heptadien-3-one |
| 141 | phenyl ethyl | 4-cyclohexyl-2-methylbutan-2-ol |
| | dimethyl carbinol | |
| 142 | phenyl ethyl | 2-phenylethyl 2-phenylacetate |
| | phenyl acetate | |
| 143 | pomarose | (2E, 5E/Z)-5,6,7-trimethyl octa-2,5-dien-4-one |
| 144 | precyclemone B | 1-methyl-3-(4-methylpent-3-enyl)cyclohex-3-ene-1- |
| | | carbaldehyde |
| 145 | romascone | methyl 2,2-dimethyl-6-methylidenecyclohexane-1- |
| | | carboxylate |
| 146 | rosamusk | 1-(3,3-dimethylcyclohexyl)ethyl acetate |
| 147 | rose oxide | 4-methyl-2-(2-methylprop-1-enyl)oxane |
| 148 | spirogalbanone | 1-spiro(4.5)-7-decen-7-yl-4-penten-1-one |
| 149 | tabanone | 4-(2-butenylidene)-3,5,5-trimethylcyclohex-2-en-1-one |
| 150 | terpineol | 2-(4-methyl-1-cyclohex-3-enyl)propan-2-ol |
| 151 | terpinolene | 4-isopropylidene-1-methyl-cyclohexene |
| 152 | terpinyl acetate | 2-(4-methyl-1-cyclohex-3-enyl)propan-2-yl acetate |
| 153 | tetrahydromuguol | 3,7-dimethyloctan-3-ol |
| 154 | tetrahydrolinalool | 3,7-dimethyloctan-3-ol |
| 155 | tetrahydrolinalyl | 3,7-dimethyloctan-3-yl acetate |
| | acetate | |
| 156 | trifernal | 3-phenylbutanal |
| 157 | triplal | (2,5-dimethyl-4-oxofuran-3-yl) acetate |
| 158 | undecavertol | 4-methyl-3-decen-5-ol |
| 159 | undecylenic | undec-10-enal |
| | aldehyde | |
| 160 | vanillin | (4-formyl-2-methoxyphenyl) 2-methylpropanoate |
| | isobutyrate | |
| 161 | veloutone | 2,2,5-trimethyl-5-pentylcyclopentan-1-one |
| 162 | verdol | 2-tert-butylcyclohexan-1-ol |
| 163 | verdox | (2-tert-butylcyclohexyl) acetate |
| 164 | vertenex | 4-tert-butylcyclohexyl acetate |
| 165 | vertofix | 1-(3-methyl-7-propan-2-yl-6-bicyclo[2.2.2]oct-3- |
| | | enyl)ethanone |
| 166 | vetivert acetate | (4,8-dimethyl-2-propan-2-ylidene-3,3a,4,5,6,8a- |
| | | hexahydro-1H-azulen-6-yl) acetate |
| 167 | violiff | [(4Z)-1-cyclooct-4-enyl] methyl carbonate |
| 168 | yara yara | methyl beta naphtyl ether |

Thus, in one aspect, a consumer product that may comprise a consumer product adjunct ingredient and a benefit agent delivery particle, wherein said benefit agent delivery particle may comprise a shell material and a core material, and wherein said shell material encapsulates said core material, and wherein said core material may comprise, one or more Table 1 materials and/or stereoisomers thereof is disclosed.

In one aspect, of the aforementioned consumer product, such product's benefit agent delivery particle's core material may comprise one or more Table 1 materials and/or and stereoisomers thereof selected from the group consisting of Table 1 materials numbers 1, 2, 4, 5, 13, 15, 18, 22, 23, 24, 31, 35, 37, 38, 41, 45, 47, 49, 50, 51, 52, 53, 54, 58, 59, 60, 61, 63, 66, 67, 68, 70, 71, 72, 76, 77, 78, 79, 80, 81, 82, 85, 86, 87, 93, 94, 95, 97, 99, 100, 102, 103, 104, 105, 106, 107, 111, 112, 113, 114, 116, 117, 120, 122, 124, 125, 126, 127, 128, 129, 130, 132, 134, 136, 137, 140, 141, 143, 144, 145, 146, 149, 151, 155, 156, 160, 162, 165, 166 and 167, said materials may be present, based total core weight, at the level of from about 0.1% to about 80%, 0.1% to about 50% or 0.1% to about 30%.

In one aspect, of the aforementioned consumer product: at least 75% of said benefit agent delivery particles may have a fracture strength of from about 0.2 MPa to about 10 MPa, from about 0.4 MPa to about 5MPa, from about 0.6 MPa to about 3.5 MPa, or even from about 0.7 MPa to about 3 MPa; said benefit agent delivery particles may have a benefit agent leakage of from about 0% to about 30%, from about 0% to about 20%, or even from about 0% to about 5%; and said benefit agent delivery particles' core material(s) may have a headspace ratio of from about 2 to about 10,000; from about 3 to about 1,000; or even from about 5 to about 1,000.

In one aspect, of the aforementioned consumer product, such product's benefit agent delivery particle's core material may comprise:
a.) one or more Table 1 materials and/or and stereoisomers thereof selected from the group consisting of Table 1 materials numbers 1, 2, 4, 5, 13, 15, 18, 22, 23, 24, 31, 35, 37, 38, 41, 45, 47, 49, 50, 51, 52, 53, 54, 58, 59, 60, 61, 63, 66, 67, 68, 70, 71, 72, 76, 77, 78, 79, 80, 81, 82, 85, 86, 87, 93, 94, 95, 97, 99, 100, 102, 103, 104, 105, 106, 107, 111, 112, 113, 114, 116, 117, 120, 122, 124, 125, 126, 127, 128, 129, 130, 132, 134, 136, 137, 140, 141, 143, 144, 145, 146, 149, 151, 155, 156, 160, 162, 165, 166, 167;
b.) a shell, said shell encapsulating said core material, said shell may comprise a resin selected from the group consisting of a reaction product of an aldehyde, in one aspect, formaldehyde, with an amine, such as an amine selected from the group consisting of melamine, urea, benzoguanamine, glycoluril, and mixtures thereof; and
c.) at least 75%, at least 85%, or even at least 90% of said benefit agent delivery particles may have a fracture strength of from about 0.2 MPa to about 10 MPa, from about 0.4 MPa to about 5 MPa, from about 0.6 MPa to about 3.5 MPa, or even from about 0.7 MPa to about 3 MPa; and a benefit agent leakage of from about 0% to about 30%, from about 0% to about 20%, or even from about 0% to about 5%; and
   such consumer product may comprise a consumer product adjunct material, said adjunct material may comprise a structurant, said structurant may comprise a material selected from the group consisting of polysaccharides, modified celluloses, modified proteins, inorganic salts, quaternized polymeric materials, imidazoles; nonionic polymers having a pKa less than 6.0, polyurethanes, and mixtures thereof; and a formaldehyde scavenger.

In one aspect of the aforementioned consumer products at least 75%, at least 85%, or even at least 90% of said benefit agent delivery particles may have a particle size of from about 1 microns to about 80 microns, about 5 microns to about 60 microns, from about 6 microns to about 40 microns, or from about 10 microns to about 35 microns.

In one aspect of the aforementioned consumer products at least 75%, at least 85%, or even at least 90% of said benefit agent delivery particles may have a particle wall thickness of from about 40 nm to about 250 nm, from about 50 nm to about 180 nm, or even from about 60 nm to about 160 nm.

In one aspect of the aforementioned consumer products said benefit agent delivery particles may comprise, based on total benefit agent delivery particle weight, at least 1 weight %, from about 20 to about 95 weight %, from about 50 to about 90 weight %, or even from about 80 to about 85 weight % of a benefit agent.

In one aspect of the aforementioned consumer products said benefit agent delivery particles' core material may comprise, based on total core material weight, at least 20, from about 50 to about 70, or even from about 60 to about 100 wt % benefit agent.

In one aspect of the aforementioned consumer products said benefit agent may comprise a perfume composition, said particles may comprise, based on total particle weight, from about 20 weight % to about 95 weight %, from about 50 weight % to about 90 weight %, from about 70 weight % to about 85 weight %, or even from about 80 weight % to about 85 weight % of said perfume composition.

In one aspect of the aforementioned consumer products said consumer products may comprise a material selected from the group consisting of a formaldehyde scavenger, a structurant, an anti-agglomeration agent and mixtures thereof.

In one aspect, of the aforementioned consumer products the consumer product may comprise from about 0.001% to about 25%, from about 0.001% to about 10%, or from about 0.01% to about 3%, based on total consumer product mass weight, of said benefit agent delivery particles.

### Treated Situs

In one aspect, a situs treated with any of the consumer products disclosed herein is disclosed. Such situs may be treated in accordance with any method disclosed herein.

Process of making a Consumer Product

In one aspect, a process of making a consumer product is disclosed. Said process may comprising combining a consumer adjunct material and a benefit agent delivery particle produced by the process of:
a.) preparing a first solution that may comprise, based on total solution weight from about 20% to about 90%, from about 40% to about 80%, or even from about 60% to about 80% water, a first emulsifier and a first resin, the ratio of said first emulsifier and said first resin may be from about 0.1:1 to about 10:1, from about 0.5:1 to about 3:1, or even from about 0.8:1 to about 1.1:1;
b.) preparing a second solution that may comprise based on total solution weight from about 20% to about 95% water, a second emulsifier and a second resin, the ratio of said second emulsifier and said second resin may be from about 0:1 to about 3:1, from about 0.04:1 to about 0.2:1, or even from about 0.05:1 to about 0.15:1;
c.) combining a core material that may comprise a material selected from the group consisting of Table I materials 1, 2, 4, 5, 13, 15, 18, 22, 23, 24, 31, 35, 37, 38, 41, 45, 47, 49, 50, 51, 52, 53, 54, 58, 59, 60, 61, 63, 66, 67, 68, 70, 71, 72, 76, 77, 78, 79, 80, 81, 82, 85, 86, 87, 93, 94, 95, 97, 99, 100, 102, 103, 104, 105, 106, 107, 111, 112, 113, 114, 116, 117, 120, 122, 124, 125, 126, 127, 128, 129, 130, 132, 134, 136, 137, 140, 141, 143, 144, 145, 146, 149, 151, 155, 156, 160, 162, 165, 166, 167, stereoisomers of such Table 1 materials and mixtures thereof and said first solution to form a first composition;
d.) emulsifying said first composition;
e.) combining said first composition and said second solution to form a second composition and optionally combining any processing aids and said second composition;
f.) mixing said second composition for at least 15 minutes, at least 1 hour or even from 4 hours to 100 hours at a temperature of from about 25° C. to about 100° C., from about 45° C. to about 90° C., or even from about 60° C. to about 85° C. heat and optionally combining any processing aids to said second composition;
g.) optionally combining any scavenger material, structurant, and/or anti-agglomeration agent with said second composition during step f.) or thereafter
h.) optionally spray drying said second composition.

In one aspect, the aforementioned consumer product may be produced according to the aforementioned process, wherein said emulsifier comprises a moiety selected from the group consisting of carboxy, hydroxyl, thiol, amine, amide and combinations thereof, said emulsifier having a pKa of less than 5, preferably greater than 0 but less than 5.

In one aspect, the aforementioned consumer product may be produced according to the aforementioned process, wherein in any of the process steps, the pH of the first and second solutions is controlled such that the pH of said first and second solution is from about 3 to about 7; from about 4.5 to about 7; or from about 5 to about 6.5.

In one aspect, the aforementioned consumer product may be produced according to the aforementioned process, wherein in step f.), from 0% to about 10%, from about 1% to about 5% or even from about 2% to about 4%, based on total second composition weight, of a salt comprising an anion and cation, said anion being selected from the group consisting of chloride, sulfate, phosphate, nitrate, polyphosphate, citrate, maleate, fumarate and mixtures thereof; and said cation being selected from the group consisting of a Periodic Group IA element, Periodic Group IIA element, ammonium cation and mixtures thereof, is combined with said second composition. In one aspect, said ion source may be sodium sulfate.

In one aspect, the perfume delivery systems disclosed herein are suitable for use in consumer products, cleaning and treatment compositions and fabric and hard surface cleaning and/or treatment compositions, detergents, and highly compacted consumer products, including highly compacted fabric and hard surface cleaning and/or treatment compositions, for example highly compacted detergents that may be solids or fluids, at levels, based on total consumer product weight, from about 0.001% to about 20%, from about 0.01% to about 10%, from about 0.05% to about 5%, from about 0.1% to about 0.5%.

The perfume delivery technologies also known as perfume delivery systems that are disclosed in the present specification may be used in any combination in any type of consumer product, cleaning and/or treatment composition, fabric and hard surface cleaning and/or treatment composition, detergent, and highly compact detergent. Furthermore, such perfume delivery systems may be combined, in any type of consumer product, cleaning and/or treatment composition, fabric and hard surface cleaning and/or treatment composition, detergent, and highly compact detergent, in any manner with the following perfume delivery systems described, for example, in USPA 2007/0275866 A1: Molecule-Assisted Delivery (MAD) systems; Fiber-Assisted Delivery (FAD) systems; Amine Assisted Delivery (AAD; Cyclodextrin Delivery System (CD); Starch Encapsulated Accord (SEA); Inorganic Carrier Delivery System (ZIC); Pro-Perfume (PP) including Amine Reaction Products (ARPs); other Polymer Assisted Delivery (PAD) systems and mixtures thereof.

### Adjunct Materials

For the purposes of the present invention, the non-limiting list of adjuncts illustrated hereinafter are suitable for use in the instant compositions and may be desirably incorporated in certain embodiments of the invention, for example to assist or enhance performance, for treatment of the substrate to be cleaned, or to modify the aesthetics of the composition as is the case with perfumes, colorants, dyes or the like. It is understood that such adjuncts are in addition to the components that are supplied via Applicants' perfumes and/or perfume systems. The precise nature of these additional components, and levels of incorporation thereof, will depend on the physical form of the composition and the nature of the operation for which it is to be used. Suitable adjunct materials include, but are not limited to, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, rheology modifiers, water processing aids and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

Each adjunct ingredient is not essential to Applicants' compositions. Thus, certain embodiments of Applicants' compositions do not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids and/or pigments. However, when one or more adjuncts are present, such one or more adjuncts may be present as detailed below:

Surfactants—The compositions according to the present invention can comprise a surfactant or surfactant system wherein the surfactant can be selected from nonionic and/or anionic and/or cationic surfactants and/or ampholytic and/or zwitterionic and/or semi-polar nonionic surfactants. The surfactant is typically present at a level of from about 0.1%, from about 1%, or even from about 5% by weight of the cleaning compositions to about 99.9%, to about 80%, to about 35%, or even to about 30% by weight of the cleaning compositions.

Builders—The compositions of the present invention can comprise one or more detergent builders or builder systems. When present, the compositions will typically comprise at least about 1% builder, or from about 5% or 10% to about 80%, 50%, or even 30% by weight, of said builder. Builders include, but are not limited to, the alkali metal, ammonium and alkanolammonium salts of polyphosphates, alkali metal silicates, alkaline earth and alkali metal carbonates, aluminosilicate builders polycarboxylate compounds. ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

Dye Transfer Inhibiting Agents—The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

Dispersants—The compositions of the present invention can also contain dispersants. Suitable water-soluble organic materials are the homo- or co-polymeric acids or their salts, in which the polycarboxylic acid may comprise at least two carboxyl radicals separated from each other by not more than two carbon atoms.

Enzymes—The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

Enzyme Stabilizers—Enzymes for use in compositions, for example, detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methyl-enephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. Nos. 5,597,936 and 5,595,967. Such cobalt catalysts are readily prepared by known procedures, such as taught for example in U.S. Pat. Nos. 5,597,936, and 5,595,967.

Compositions herein may also suitably include a transition metal complex of a macropolycyclic rigid ligand—abbreviated as “MRL”. As a practical matter, and not by way of limitation, the compositions and cleaning processes herein can be adjusted to provide on the order of at least one part per hundred million of the benefit agent MRL species in the aqueous washing medium, and may provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include manganese, iron and chromium. Suitable MRL' s herein are a special type of ultra-rigid ligand that is cross-bridged such as 5,12-diethyl-1,5,8,12-tetraazabicyclo[6.6.2]hexa-decane.

Suitable transition metal MRLs are readily prepared by known procedures, such as taught for example in WO 00/32601, and U.S. Pat. No. 6,225,464.

### Method of Use

Consumer products disclosed herein may be used to clean or treat a situs inter alia a surface or fabric. Typically at least a portion of the situs is contacted with an embodiment of Applicants' composition, in neat form or diluted in a liquor, for example, a wash liquor and then the situs may be optionally washed and/or rinsed. In one aspect, a situs is optionally washed and/or rinsed, contacted with a particle according to the present invention or composition comprising said particle and then optionally washed and/or rinsed. For purposes of the present invention, washing includes but is not limited to, scrubbing, and mechanical agitation. If the situs comprises a fabric, the fabric may comprise most any fabric capable of being laundered or treated in normal consumer use conditions. Liquors that may comprise the disclosed compositions may have a pH of from about 3 to about 11.5. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1.

### Test Methods

### (1) Fracture Strength

a.) Place 1 gram of particles in 1 liter of distilled deionized (DI) water.
b.) Permit the particles to remain in the DI water for 10 minutes and then recover the particles by filtration, using a 60 mL syringe filter, 1.2 micron nitrocellulose filter (Millipore, 25 mm diameter).
c.) Determine the rupture force of 30 individual particles. The rupture force of a particle is determined using the procedure given in Zhang, Z.; Sun, G; “Mechanical Properties of Melamine-Formaldehyde microcapsules,” J. Microencapsulation, vol 18, no. 5, pages 593-602, 2001. Then calculate the fracture strength of each particle by dividing the rupture force (in Newtons) by the cross-sectional area of the respective spherical particle (πr², where r is the radius of the particle before compression), said cross-sectional area being determined as follows: measuring the particle size of each individual particle using the experimental apparatus and method of Zhang, Z.; Sun, G; “Mechanical Properties of Melamine-Formaldehyde microcapsules,” J. Microencapsulation, vol 18, no. 5, pages 593-602, 2001.
d.) Use the 30 independent measurements from c.) above, and calculate the percentage of particles having a fracture strength within the claimed range fracture strength range.

### (2) Particle Size

a.) Place 1 gram of particles in 1 liter of distilled deionized (DI) water.
b.) Permit the particles to remain in the DI water for 10 minutes and then recover the particles by filtration, using a 60 mL syringe filter, 1.2 micron nitrocellulose filter (Millipore, 25 mm diameter).
c.) Determine the particle size of 30 individual particles using the experimental apparatus and method of Zhang, Z.; Sun, G; “Mechanical Properties of Melamine-Formaldehyde microcapsules,” J. Microencapsulation, vol 18, no. 5, pages 593-602, 2001.
d.) Use the 30 independent measurements from c.) above, and calculate the percentage of particles having a particle size within the claimed range.

### (3) Particle Wall Thickness

All references to Leica Microsystems refer to the Company with Corporate Headquarters located at:
Leica Microsystems GmbH
Ernst-Leitz-Strasse 17-37
35578 Wetzlar

All references to Drummond refer to the Company located at:
Drummond Scientific Company
500 Parkway, Box 700
Broomall, Pa. 19008

All references to Hitachi refer to the Company with Corporate Headquarters located at:
Hitachi High Technologies
24-14, Nishi-Shimbashi 1-chome, Minato-ku,
Tokyo 105-8717, Japan

All references to Gatan refer to the Company with Corporate Headquarters located at:
Gatan, Inc.
5933 Coronado Lane
Pleasanton, Calif. 94588

All references to Quartz refer to the Company with offices located at:
Quartz Imaging Corporation
Technology Enterprise Facility III
6190 Agronomy Rd, Suite 406
Vancouver, B.C. Canada V6T 1Z3

Materials:
Methylcyclohexane—Alfa Aesar Catalogue Number A16057 or equivalent
Capillary Pipettes—Drummond Catalogue Number 5-000-1005 or equivalent
Flat Specimen Carrier—Leica Microsystems P/N 706897 or equivalent
Copper Washers—Leica Microsystems P/N 706867 or equivalent
Flat Specimen Pod—Leica Microsystems P/N 706839 or equivalent
Loading Device for Flat Specimen Holder—Leica Microsystems P/N 706832 or equivalent
Torque Wrench—Leica Microsystems P/N 870071 or equivalent
Allen Bit, 2 mm—Leica Microsystems P/N 870072 or equivalent
Forceps—Leica Microsystems P/N 840105 or equivalent
Gatan Planchette Collet—Gatan P/N PEP5099
Gatan Planchette Specimen Holder—Gatan P/N PEP1395

Instruments:
Scanning Electron Microscope—Hitachi Model S-5200 SEM/STEM or equivalent
High Pressure Freezer—Leica Microsystems Model 706802 EM Pact or equivalent
Cryotransfer Device—Gatan Model CT3500 or equivalent
Cryotransfer System—Gatan Model CT2500 or equivalent
Gatan ITC Temperature Controller—Gatan Model ITC502 or equivalent
Image Analysis Software—Quartz PCI Version 5 or equivalent
Sample: Obtain the sample of microcapsules as per the procedure of 1 above entitled “Fracture Strength”. 50 samples are required.

Test Procedure
1) Turn on the Leica Microsystems High Pressure Freezer (Leica Microsystems Model Number 706802).
2) Fill up the methylcyclohexane container on the High Pressure Freezer with methylcyclohexane (Alfa Aesar Cat. #A16057 or equivalent).
3) Fill up the liquid nitrogen dewar on the High Pressure Freezer.
4) Fill the liquid nitrogen bath on the High Pressure Freezer
5) The display on the High Pressure Freezer will show Load Sample on the front panel when the instrument is ready to use.
6) Start the Hitachi Model S-5200 SEM/STEM and set the Accelerating Voltage to 3.0 KV and the Emission Current to 20 μA.
7) Fill the Anti-contaminator Dewar located on the lower right side of the Hitachi Model S-5200 SEM/STEM microscope column with liquid nitrogen.
8) Fill the liquid nitrogen dewar on the Gatan Alto 2500 Cryotransfer System (Gatan Model CT2500). Replenish the liquid nitrogen until the dewar remains full. The device is ready to use when the prepchamber temperature reads below −190° C.
9) Place a copper washer (Leica Microsystems P/N 706867) on top of the flat specimen carrier such that the hole in the washer aligns with the well in the flat specimen carrier.
10) Take a glass capillary pipette (Drummond P/N 5-000-1005 or similar) and insert the provided wire plunger into one end of the pipette
11) Insert the pipette into the microcapsule dispersion and withdraw the plunger part way to pull a few microliters of the dispersion into the pipette.
12) Place the tip of the pipette in the well in the flat specimen carrier and push the plunger into the pipette to dispense a small amount of liquid until the well is just slightly overfilled.
13) Insert a 2 mm Allen key bit (Leica Microsystems P/N 870072) into the torque wrench (Leica Microsystems P/N 870071).
14) Using the torque wrench with the bit, loosen the Diamond Locking Screw in the Flat Specimen Pod (Leica Microsystems P/N 706839).
15) Place the Flat Specimen Holder and Copper Washer into the Flat Specimen Pod.
16) Use the torque wrench with the 2 mm Allen key bit to tighten the Diamond Locking Screw in the Flat Specimen Pod onto the specimen until the torque wrench clicks twice.
17) Attach the Loading Device for the Flat Specimen Holder (Leica Microsystems P/N 706832) to the Flat Specimen Pod by screwing it onto the exposed threads of the Diamond Locking Screw.
18) Place the Loading Device for the Flat Specimen Holder with the Flat Specimen Pod onto the EM Pact High Pressure Freezer (Leica Microsystems P/N 706802) and insert it into the High Pressure Freezer.
19) Freeze the specimen using the High Pressure Freezer.
20) Transfer the Flat Specimen Pod to the Unloading Station and unscrew the Loading Device for the Flat Specimen Carrier being careful to keep it immersed in the liquid nitrogen bath.
21) Using the torque wrench, loosen the Diamond Locking Screw.
22) Using tweezers with the tips cooled in liquid nitrogen until the liquid nitrogen stops boiling, remove the Flat Specimen Carrier from the Flat Specimen Pod and place it into a small container in the liquid nitrogen bath.
23) Place the Gatan CT3500 Cryotransfer Device (Gatan Model Number CT3500) into the Gatan Specimen Workstation.
24) Fill the liquid nitrogen dewar on the Gatan CT3500 Cryotransfer device and fill the dewar on the Gatan Specimen Workstation replenishing the liquid nitrogen as necessary until rapid boiling of the liquid nitrogen stops.
25) Transfer the Flat Specimen Holder to the Gatan Specimen Workstation while keeping it in a container of liquid nitrogen.
26) Using tweezers cooled in liquid nitrogen until the liquid nitrogen stops boiling, place the flat specimen holder into the Gatan Planchette Collet (Gatan P/N PEP5099) and press down firmly.
27) Place the assembly from step 26 into the Gatan Planchette Specimen Holder (Gatan P/N PEP1395) and press down firmly.
28) Push the Gatan Cryotransfer device back into the Gatan Specimen Workstation.
29) Using the Gatan supplied 5 mm Friction Tool, screw the Gatan Planchette Specimen Holder into the Gatan Cryotransfer device.
30) Remove the Gatan Cryotransfer device from the Gatan Specimen Workstation and insert it into the Gatan Alto 2500 Cryotransfer System.
31) Attach the Gatan ITC Temperature Controller (Gatan Model Number ITC502) to the Gatan Cryotransfer device by attaching the Temperature Measurement Lead from the Gatan ITC controller to the connector on top of the Gatan Cryotransfer device.
32) Using the Gatan ITC Controller, raise the temperature of the specimen to −120° C.
33) Using the fracturing knife, break off the copper washer to fracture the specimen.
34) Reduce the temperature of the specimen below −160° C.
35) With the voltage set to 6 KV and the gas flow set to provide 10 mA sputter current, press the sputter button and once the current displays 10 mA, let the coater run for 60-90 seconds coating the specimen with gold/palladium.
36) Close the frost shield on the Gatan CT3500 Cryotransfer Device and transfer the specimen to the Hitachi S-5200 SEM/STEM.
37) Wait for the temperature of the Gatan CT3500 Cryotransfer device to stabilize, typically between −170° C. and −172° C.
38) Open the frost shield on the Gatan CT3500 Cryotransfer device by turning the frost shield control knob counter-clockwise.
39) Move the sample around using the stage control trackball, locate a broken microcapsule and adjust the magnification to 50,000 to 150,000×.
40) Adjust the focus and stigmation controls to obtain the best image.
41) Acquire an image of the cross-section of the capsule wall.

Calculations
1) Select the ruler tool in the Quartz PCI software.
2) Move the cursor to one edge of the microcapsule wall.
3) Click and hold the left mouse button while dragging the mouse cursor to the opposite side of the capsule wall keeping the drawn line perpendicular to the face of the capsule wall to measure the wall thickness.
4) Use 50 independent measurements (1 measurement for each capsule) to calculate the percentage of particles having a wall thickness in the claimed range.

(4) Benefit Agent Leakage
a.) Obtain 2, one gram samples of benefit agent particle composition.
b.) Add 1 gram (Sample 1) of particle composition to 99 grams of product matrix that the particle will be employed in and with the second sample immediately proceed to Step d below.
c.) Age the particle containing product matrix (Sample 1) of a.) above for 1 week at 35° C. in a sealed, glass jar.
d.) Recover the particle composition's particles from the product matrix of c.) (Sample 1 in product matrix) and from particle composition (Sample 2) above by filtration.
e.) Treat each particle sample from d.) above with a solvent that will extract all the benefit agent from each samples' particles.
f.) Inject the benefit agent containing solvent from each sample from e.) above into a Gas Chromatograph and integrate the peak areas to determine the total quantity of benefit agent extracted from each sample.
g.) The benefit agent leakage is defined as:
   Value from f.) above for Sample 2—Value from f.) above for Sample 1.

### 5. Method for Determining Headspace Ratio

Dynamic headspace (vapor phase) sampling above treated fabrics enables detection and quantitation of perfume volatiles. Basically, the volatiles present in the headspace above fabrics are collected on a Tenax-TA sorbent trap in a controlled (known headspace volume, sampling flow rate, temperature and pressure) manner. This is achieved by either displacing the vapor phase with an inert gas-stream (e.g. helium) or by means of a headspace sampling pump, to trap volatiles on the sorbent medium. Subsequently, the trapped volatiles are on-line thermally desorbed into the injection-port of a GC and cryo-focussed. Finally, the headspace-extracts are analyzed by capillary GC hyphenated to mass spectrometry.
A technology leg needs to be analyzed in parallel with a nil-technology fabric (reference), containing equal perfume levels.
Method Details:
   About 40 g of fabric is placed in a closed headspace vessel of 1 L and stored at ambient conditions overnight.
   2 L of headspace is collected (40 min at 50 ml/min flow rate) onto the Tenax-TA trap at ambient conditions (known temperature, pressure)
   Thermally desorb trap at 180° C. for 10 minutes into the injection-port of GC
   Run GC-MS analysis: GC separation on apolar stationary phase, followed by mass spectrometry in full scan mode (70 eV)
   The headspace responses (full scan and/or SIM MS based) of each perfume component in the applied perfume oil, are monitored for both technology and nil-technology leg. The headspace ratio, for each perfume component, is defined as the headspace of the perfume compounds delivered by the technology divided by the headspace of the perfume compounds delivered without the technology.
      The average overall headspace ratio for a benefit agent particle delivery particle is defined as the sum of the headspace ratios for each of the core's benefit agents divided by the total number of the core's benefits.

### Examples

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

### 84 wt % Core/16 wt % Wall Melamine Formaldehyde (MF) Capsule

25 grams of butyl acrylate-acrylic acid copolymer emulsifier (Colloid C351, 25% solids, pka 4.5-4.7, (Kemira Chemicals, Inc. Kennesaw, Ga. U.S.A.) is dissolved and mixed in 200 grams deionized water. The pH of the solution is adjusted to pH of 4.0 with sodium hydroxide solution. 8 grams of partially methylated methylol melamine resin (Cymel 385, 80% solids, (Cytec Industries West Paterson, N.J., U.S.A.)) is added to the emulsifier solution. 200 grams of perfume oil is added to the previous mixture under mechanical agitation and the temperature is raised to 50° C. After mixing at higher speed until a stable emulsion is obtained, the second solution and 4 grams of sodium sulfate salt are added to the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.8, 25 grams of partially methylated methylol melamine resin (Cymel 385, 80% solids, Cytec). This mixture is heated to 70° C. and maintained overnight with continuous stifling to complete the encapsulation process. 23 grams of acetoacetamide (Sigma-Aldrich, Saint Louis, Mo., U.S.A.) is added to the suspension. An average capsule size of 30 um is obtained as analyzed by a Model 780 Accusizer.

### Example 2

### 80 wt % Core/20 wt % Wall Melamine Formaldehyde Capsule

18 grams of a blend of 50% butyl acrylate-acrylic acid copolymer emulsifier (Colloid C351, 25% solids, pka 4.5-4.7, Kemira) and 50% polyacrylic acid (35% solids, pKa 1.5-2.5, Aldrich) is dissolved and mixed in 200 grams deionized water. The pH of the solution is adjusted to pH of 3.5 with sodium hydroxide solution. 6.5 grams of partially methylated methylol melamine resin (Cymel 385, 80% solids Cytec) is added to the emulsifier solution. 200 grams of perfume oil is added to the previous mixture under mechanical agitation and the temperature is raised to 60° C. After mixing at higher speed until a stable emulsion is obtained, the second solution and 3.5 grams of sodium sulfate salt are poured into the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.6, 30 grams of partially methylated methylol melamine resin (Cymel 385, 80% Cytec). This mixture is heated to 75° C. and maintained 6 hours with continuous stifling to complete the encapsulation process. 23 grams of acetoacetamide (Sigma-Aldrich, Saint Louis, Mo., U.S.A.) is added to the suspension.

### Example 3

### 80 wt % Core/20 wt % Melamine Formaldehyde Wall Capsule

36 grams of butyl acrylate-acrylic acid copolymer emulsifier (Colloid C351, 25% solids, pKa 4.5-4.7, Kemira) is dissolved and mixed in 200 grams deionized water. The pH of the solution is adjusted to pH of 5.0 with sodium hydroxide solution. 12 grams of partially methylated methylol melamine resin (Cymel 385, 80% solids, Cytec) is added to the emulsifier solution. 200 grams of perfume oil is added to the previous mixture under mechanical agitation and the temperature is raised to 65° C. After mixing at higher speed until a stable emulsion is obtained, the second solution and 5 grams of sodium sulfate salt are added to the emulsion. This second solution contains 12 grams of butyl acrylate-acrylic acid copolymer emulsifier (Colloid C351, 25% solids, pKa 4.5-4.7, Kemira), 120 grams of distilled water, sodium hydroxide solution to adjust pH to 5, 33 grams of partially methylated methylol melamine resin (Cymel 385, 80% solids, Cytec). This mixture is heated to 65° C. and maintained overnight with continuous stifling to complete the encapsulation process. 23 grams of acetoacetamide (Sigma-Aldrich, Saint Louis, Mo., U.S.A.) is added to the suspension.

### Example 4

### 80 wt % Core/20 wt % Wall Melamine Formaldehyde Capsule

20 grams of butyl acrylate-acrylic acid copolymer emulsifier (Colloid C351, 25% solids, pKa 4.5-4.7, Kemira) is dissolved and mixed in 200 grams deionized water. The pH of the solution is adjusted to pH of 5.5 with sodium hydroxide solution. 6 grams of partially methylated methylol melamine resin (Cymel 385, 80% solids, Cytec) is added to the emulsifier solution. 200 grams of perfume oil is added to the previous mixture under mechanical agitation and the temperature is raised to 55° C. After mixing at higher speed until a stable emulsion is obtained, the second solution and 9 grams of sodium sulfate salt is added to the emulsion. This second solution contains 8 grams of polyacrylic acid (35% solids, pka 1.5-2.5, Aldrich), 120 grams of distilled water, sodium hydroxide solution to adjust pH to 4.4, 35 grams of partially methylated methylol melamine resin (Cymel 385, 80% solids, Cytec). This mixture is heated to 85° C. and maintained 8 hours with continuous stifling to complete the encapsulation process. 23 grams of acetoacetamide (Sigma-Aldrich, Saint Louis, Mo., U.S.A.) is added to the suspension.

### Example 5

### Melamine Formaldehyde Capsule

The composition of and the procedures for preparing the capsules are the same composition as in Example 4 except for the following: the melamine formaldehyde resin is a mix of 80% partially methylated methylol melamine resin and 20% of fully methylated melamine resin.

### Example 6

### Melamine Formaldehyde Capsule

The procedure for preparing the capsules is the same as in Example 4, except for the following compositional changes to the perfume emulsification liquor (the first solution):

| Material | A | B | C | D | E | F | G |
|---|---|---|---|---|---|---|---|
| Copolymer of | 42 | 31 | 0 | 20 | 26 | 18 | 0 |
| Polyacrylic Acid- | | | | | | | |
| Butyl Acrylate | | | | | | | |
| Polyacrylic Acid | 0 | 21 | 29 | 14 | 0 | 22 | 27 |
| 20% NaOH | 2 | 3 | 6 | 9 | 2 | 7 | 7 |
| Melamine Resin | 19 | 21 | 21 | 8 | 4 | 7 | 17 |
| Perfume Oil | 265 | 290 | 246 | 224 | 220 | 200 | 204 |
| Water | 95 | 104 | 103 | 225 | 159 | 189 | 237 |

The procedure for preparing the capsules is the same as in Example 4, except for the following compositional changes to the second solution:

| Material | A | B | C | D | E | F | G |
|---|---|---|---|---|---|---|---|
| Copolymer of | 11 | 0 | 15 | 0 | 0 | 3 | 3 |
| Polyacrylic Acid- | | | | | | | |
| Butyl Acrylate | | | | | | | |
| Polyacrylic Acid | 11 | 12 | 0 | 4 | 9 | 8 | 10 |
| 20% NaOH | 0.4 | 0.4 | 0.1 | 0.3 | 0.4 | 0.4 | 0.4 |
| Melamine Resin | 8 | 4 | 16 | 13 | 26 | 23 | 29 |
| Water | 115 | 126 | 43 | 147 | 52 | 47 | 78 |

Followed by the addition of acetoacetamide at a level of 5 wt % of the weight of the batch.

### Example 7

### Melamine Formaldehyde Capsule

The composition of and the procedures for preparing the capsules are the same composition as in Example 4 except for the following: 0.7% of ammonium hydroxide is added to the suspension instead of acetoacetamide.

### Example 8

### Production of Spray Dried Microcapsule

1200 g of perfume microcapsule slurry, containing one or more of the variants of microcapsules disclosed in the present specification, is mixed together with 700 g of water for 10 minutes using an IKA Eurostar mixer with R1382 attachment at a speed of 180 rpm. The mixture is then transferred over to a feeding vessel to be spray dried in a 1.2 m diameter Niro Production Minor. The slurry is fed into the tower using a Watson-Marlow 504U peristaltic pump and atomised using a 100 mm diameter rotary atomiser run at 18000 rpm, with co-current air flow for drying. The slurry is dried using an inlet temperature of 200° C. and outlet temperature of 95° C. to form a fine powder. The equipment used the spray drying process may be obtained from the following suppliers: IKA Werke GmbH & Co. KG, Janke and Kunkel—Str. 10, D79219 Staufen, Germany; Niro A/S Gladsaxevej 305, P.O. Box 45, 2860 Soeborg, Denmark and Watson-Marlow Bredel Pumps Limited, Falmouth, Cornwall, TR11 4RU, England.

### Example 9

### Product Formulation

Non-limiting examples of product formulations containing PRMs disclosed in the present specification perfume and amines summarized in the following table.

| | EXAMPLES | | | | | | | | | |
|---|---|---|---|---|---|---|---|---|---|---|
| (% wt) | XI | XII | XIII | XIV | XV | XVI | XVII | XVIII | XIX | XX |
| FSA ^{a} | 14 | 16.47 | 14 | 12 | 12 | 16.47 | — | — | 5 | 5 |
| FSA ^{b} | | | | | — | | 3.00 | — | — | — |
| FSA ^{c} | | | | | — | | — | 6.5 | — | — |
| Ethanol | 2.18 | 2.57 | 2.18 | 1.95 | 1.95 | 2.57 | — | — | 0.81 | 0.81 |
| Isopropyl | — | — | — | — | — | — | 0.33 | 1.22 | — | — |
| Alcohol | | | | | | | | | | |
| Starch ^{d} | 1.25 | 1.47 | 2.00 | 1.25 | — | 2.30 | 0.5 | 0.70 | 0.71 | 0.42 |
| Perfume X ^{e} | 1.2 | 0.39 | 0.195 | 0.75 | 0.09 | 0.09 | 0.09 | 0.195 | 0.09 | 0.09 |
| Phase | 0.21 | 0.25 | 0.21 | 0.21 | 0.14 | — | — | 0.14 | — | — |
| Stabilizing | | | | | | | | | | |
| Polymer ^{f} | | | | | | | | | | |
| Suds | — | — | — | — | — | — | — | 0.1 | — | — |
| Suppressor ^{g} | | | | | | | | | | |
| Calcium | 0.15 | 0.176 | 0.15 | 0.15 | 0.30 | 0.176 | — | 0.1-0.15 | — | — |
| Chloride | | | | | | | | | | |
| DTPA ^{h} | 0.017 | 0.017 | 0.017 | 0.017 | 0.007 | 0.007 | 0.20 | — | 0.002 | 0.002 |
| Preservative | 5 | 5 | 5 | 5 | 5 | 5 | — | 250 ^{j} | 5 | 5 |
| (ppm) ^{i, j} | | | | | | | | | | |
| Antifoam ^{k} | 0.015 | 0.018 | 0.015 | 0.015 | 0.015 | 0.015 | — | — | 0.015 | 0.015 |
| Dye | 40 | 40 | 40 | 40 | 40 | 40 | 11 | 30-300 | 30 | 30 |
| (ppm) | | | | | | | | | | |
| Ammonium | 0.100 | 0.118 | 0.100 | 0.100 | 0.115 | 0.115 | — | — | — | — |
| Chloride | | | | | | | | | | |
| HCl | 0.012 | 0.014 | 0.012 | 0.012 | 0.028 | 0.028 | 0.016 | 0.025 | 0.011 | 0.011 |
| Structurant ^{l} | 0.01 | 0.01 | 0.01 | 0.01 | 0.01 | 0.01 | 0.01 | 0.01 | 0.01 | 0.01 |
| Additional | 0.8 | 0.7 | 0.9 | 0.5 | 1.2 | 0.5 | 1.1 | 0.6 | 1.0 | 0.9 |
| Neat | | | | | | | | | | |
| Perfume | | | | | | | | | | |
| Deionized | † | † | † | † | † | † | † | † | † | † |
| Water | | | | | | | | | | |

^{a} N,N-di(tallowoyloxyethyl)-N,N-dimethylammonium chloride.
^{b} Methyl bis(tallow amidoethyl)2-hydroxyethyl ammonium methyl sulfate.
^{c} Reaction product of Fatty acid with Methyldiethanolamine in a molar ratio 1.5:1, quaternized with Methylchloride, resulting in a 1:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.
^{d} Cationic high amylose maize starch available from National Starch under the trade name CATO ®.
^{e} Perfume in the form of any benefit agent delivery particle disclosed in the present specification.
^{f} Copolymer of ethylene oxide and terephthalate having the formula described in U.S. Pat. No. 5,574,179 at col. 15, lines 1-5, wherein each X is methyl, each n is 40, u is 4, each R1 is essentially 1,4-phenylene moieties, each R2 is essentially ethylene, 1,2-propylene moieties, or mixtures thereof.
^{g} SE39 from Wacker
^{h} Diethylenetriaminepentaacetic acid.
ⁱ KATHON ® CG available from Rohm and Haas Co. “PPM” is “parts per million.”
^{j} Gluteraldehyde
^{k} Silicone antifoam agent available from Dow Corning Corp. under the trade name DC2310.
^{l} Hydrophobically-modified ethoxylated urethane available from Rohm and Haas under the tradename Aculan 44.
† balance

### Example 10

### Dry Laundry Formulations

| | % w/w granular laundry detergent composition | | | | | | |
|---|---|---|---|---|---|---|---|
| Component | A | B | C | D | E | F | G |
| Brightener | 0.1 | 0.1 | 0.1 | 0.2 | 0.1 | 0.2 | 0.1 |
| Soap | 0.6 | 0.6 | 0.6 | 0.6 | 0.6 | 0.6 | 0.6 |
| Ethylenediamine disuccinic acid | 0.1 | 0.1 | 0.1 | 0.1 | 0.1 | 0.1 | 0.1 |
| Acrylate/maleate copolymer | 1.5 | 1.5 | 1.5 | 1.5 | 1.5 | 1.5 | 1.5 |
| Hydroxyethane di(methylene | 0.4 | 0.4 | 0.4 | 0.4 | 0.4 | 0.4 | 0.4 |
| phosphonic acid) | | | | | | | |
| Mono-C₁₂₋₁₄ alkyl, di-methyl, | 0.5 | 0.5 | 0.5 | 0.5 | 0.5 | 0.5 | 0.5 |
| mono-hydroyethyl quaternary | | | | | | | |
| ammonium chloride | | | | | | | |
| Linear alkyl benzene | 0.1 | 0.1 | 0.2 | 0.1 | 0.1 | 0.2 | 0.1 |
| Linear alkyl benzene sulphonate | 10.3 | 10.1 | 19.9 | 14.7 | 10.3 | 17 | 10.5 |
| Magnesium sulphate | 0.4 | 0.4 | 0.4 | 0.4 | 0.4 | 0.4 | 0.4 |
| Sodium carbonate | 19.5 | 19.2 | 10.1 | 18.5 | 29.9 | 10.1 | 16.8 |
| Sodium sulphate | 29.6 | 29.8 | 38.8 | 15.1 | 24.4 | 19.7 | 19.1 |
| Sodium Chloride | 0.1 | 0.1 | 0.1 | 0.1 | 0.1 | 0.1 | 0.1 |
| Zeolite | 9.6 | 9.4 | 8.1 | 18 | 10 | 13.2 | 17.3 |
| Photobleach particle | 0.1 | 0.1 | 0.2 | 0.1 | 0.2 | 0.1 | 0.2 |
| Blue and red carbonate speckles | 1.8 | 1.8 | 1.8 | 1.8 | 1.8 | 1.8 | 1.8 |
| Ethoxylated Alcohol AE7 | 1 | 1 | 1 | 1 | 1 | 1 | 1 |
| Tetraacetyl ethylene diamine | 0.9 | 0.9 | 0.9 | 0.9 | 0.9 | 0.9 | 0.9 |
| agglomerate (92 wt % active) | | | | | | | |
| Citric acid | 1.4 | 1.4 | 1.4 | 1.4 | 1.4 | 1.4 | 1.4 |
| PDMS/clay agglomerates (9.5% | 10.5 | 10.3 | 5 | 15 | 5.1 | 7.3 | 10.2 |
| wt % active PDMS) | | | | | | | |
| Polyethylene oxide | 0.2 | 0.2 | 0.2 | 0.2 | 0.2 | 0.2 | 0.2 |
| Enzymes e.g. Protease (84 mg/g | 0.2 | 0.3 | 0.2 | 0.1 | 0.2 | 0.1 | 0.2 |
| active), Amylase (22 mg/g active) | | | | | | | |
| Suds suppressor agglomerate | 0.2 | 0.2 | 0.2 | 0.2 | 0.2 | 0.2 | 0.2 |
| (12.4 wt % active) | | | | | | | |
| Sodium percarbonate (having | 7.2 | 7.1 | 4.9 | 5.4 | 6.9 | 19.3 | 13.1 |
| from 12% to 15% active AvOx) | | | | | | | |
| Additional Neat Perfume** | 0.5 | 0.5 | 0.5 | 0.5 | 0.5 | 0.5 | 0.5 |
| Perfume X* | 0.15 | 1 | 0.3 | 2 | 0.6 | 1.2 | 3 |
| Water | 1.4 | 1.4 | 1.4 | 1.4 | 1.4 | 1.4 | 1.4 |
| Misc | 0.1 | 0.1 | 0.1 | 0.1 | 0.1 | 0.1 | 0.1 |
| Total Parts | 100 | 100 | 100 | 100 | 100 | 100 | 100 |

*Perfume in the form of any benefit agent delivery particle disclosed in the present specification.
**Optional

### Example 11

### Liquid Laundry Formulations (HDLs)

| Ingredient | HDL 1 | HDL 2 | HDL3 | HDL4 | HDL 5 | HDL 6 |
|---|---|---|---|---|---|---|
| Alkyl Ether Sulphate | 0.00 | 0.50 | 12.0 | 12.0 | 6.0 | 7.0 |
| Dodecyl Benzene | 8.0 | 8.0 | 1.0 | 1.0 | 2.0 | 3.0 |
| Sulphonic Acid | | | | | | |
| Ethoxylated Alcohol | 8.0 | 6.0 | 5.0 | 7.0 | 5.0 | 3.0 |
| Citric Acid | 5.0 | 3.0 | 3.0 | 5.0 | 2.0 | 3.0 |
| Fatty Acid | 3.0 | 5.0 | 5.0 | 3.0 | 6.0 | 5.0 |
| Ethoxysulfated | 1.9 | 1.2 | 1.5 | 2.0 | 1.0 | 1.0 |
| hexamethylene diamine | | | | | | |
| quaternized | | | | | | |
| Diethylene triamine penta | 0.3 | 0.2 | 0.2 | 0.3 | 0.1 | 0.2 |
| methylene phosphonic acid | | | | | | |
| Enzymes | 1.20 | 0.80 | 0 | 1.2 | 0 | 0.8 |
| Brightener (disulphonated | 0.14 | 0.09 | 0 | 0.14 | 0.01 | 0.09 |
| diamino stilbene based | | | | | | |
| FWA) | | | | | | |
| Cationic hydroxyethyl | 0 | 0 | 0.10 | 0 | 0.200 | 0.30 |
| cellulose | | | | | | |
| Poly(acrylamide-co- | 0 | 0 | 0 | 0.50 | 0.10 | 0 |
| diallyldimethylammonium | | | | | | |
| chloride) | | | | | | |
| Hydrogenated Castor Oil | 0.50 | 0.44 | 0.2 | 0.2 | 0.3 | 0.3 |
| Structurant | | | | | | |
| Boric acid | 2.4 | 1.5 | 1.0 | 2.4 | 1.0 | 1.5 |
| Ethanol | 0.50 | 1.0 | 2.0 | 2.0 | 1.0 | 1.0 |
| 1,2 propanediol | 2.0 | 3.0 | 1.0 | 1.0 | 0.01 | 0.01 |
| Glutaraldehyde | 0 | 0 | 19 ppm | 0 | 13 ppm | 0 |
| Diethyleneglycol (DEG) | 1.6 | 0 | 0 | 0 | 0 | 0 |
| 2,3-Methyl-1,3- | 1.0 | 1.0 | 0 | 0 | 0 | 0 |
| propanediol (M pdiol) | | | | | | |
| Mono Ethanol Amine | 1.0 | 0.5 | 0 | 0 | 0 | 0 |
| NaOH Sufficient To | pH 8 | pH 8 | pH 8 | pH 8 | pH 8 | pH 8 |
| Provide Formulation pH of: | | | | | | |
| Sodium Cumene | 2.00 | 0 | 0 | 0 | 0 | 0 |
| Sulphonate (NaCS) | | | | | | |
| Silicone (PDMS) emulsion | 0.003 | 0.003 | 0.003 | 0.003 | 0.003 | 0.003 |
| Additional Neat Perfume** | 0.7 | 0.5 | 0.8 | 0.8 | 0.6 | 0.6 |
| Perfume X*4 | 0.6 | 0.06 | 1.2 | 1 | 2 | 3 |
| Water | Balance | Balance | Balance | Balance | Balance | Balance |

*Perfume in the form of any benefit agent delivery particle disclosed in the present specification.
**Optional.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A consumer product comprising a benefit agent delivery particle, said benefit agent delivery particle comprising a shell material and a core material, said shell material encapsulating said core material, said core material comprising one or more materials selected from the group consisting of (5-methyl-2-propan-2-ylcyclohexyl)acetate; 3,7-dimethyloct-6-en-1-al; 2-(phenoxy)ethyl 2-methylpropanoate; prop-2-enyl 2-(3-methylbutoxy)acetate; 3-methyl-1-isobutylbutyl acetate; prop-2-enyl hexanoate; prop-2-enyl 3-cyclohexylpropanoate; prop-2-enyl heptanoate; (E)-1-(2,6,6-trimethyl-1-cyclohex-2-enyl)but-2-en-1-one; (E)-4-(2,6,6-trimethyl-1-cyclohex-2-enyl)but-3-en-2-one; (E)-3-methyl-4-(2,6,6-trimethyl-1-cyclohex-2-enyl)but-3-en-2-one; 1-(2,6,6-trimethyl-1-cyclohex-2-enyl)pent-1-en-3-one; 6,6,9a-trimethyl-1,2,3a,4,5,5a,7,8,9,9b-decahydronaphtho[2,1-b]furan; pentyl 2-hydroxybenzoate; 7,7-dimethyl-2-methylidene-norbornane; (E)-1-(2,6,6-trimethyl-1-cyclohexenyl)but-2-en-1-one; (E)-4-(2,6,6-trimethyl-1-cyclohexenyl)but-3-en-2-one; 4-ethoxy-4,8,8-trimethyl-9-methylidenebicyclo[3.3.1]nonane; (1,7,7-trimethyl-6-bicyclo[2.2.1]heptanyl)acetate; 3-(4-tert-butylphenyl)propanal; 1,1,2,3,3-pentamethyl-2,5,6,7-tetrahydroinden-4-one; 2-oxabicyclo2.2.2octane,1methyl4(2,2,3trimethylcyclopentyl); [(Z)-hex-3-enyl]acetate; [(Z)-hex-3-enyl]2-methylbutanoate; cis-3-hexenyl 2-hydroxybenzoate; 3,7-dimethylocta-2,6-dienal; 3,7-dimethyloct-6-en-1-al; 3,7-dimethyl-6-octen-1-ol; 3,7-dimethyloct-6-enyl acetate; 3,7-dimethyloct-6-enenitrile; 2-(3,7-dimethyloct-6-enoxy)acetaldehyde; tetrahydro-4-methyl-2-propyl-2h-pyran-4-yl acetate; ethyl 3-phenyloxirane-2-carboxylate; hexahydro-4,7-methano-indenyl isobutyrate; 2,4-dimethylcyclohex-3-ene-1-carbaldehyde; hexahydro-4,7-methano-indenyl propionate; 2-cyclohexylethyl acetate; 2-pentylcyclopentan-1-ol; (2R,3R,4S,5S,6R)-2-[(2R,3S,4R,5R,6R)-6-(6-cyclohexylhexoxy)-4,5-dihydroxy-2-(hydroxymethyl)oxan-3-yl]oxy-6-(hydroxymethyl)oxane-3,4,5-triol; (E)-1-(2,6,6-trimethyl-1-cyclohexa-1,3-dienyl)but-2-en-1-one; 1-cyclohexylethyl (E)-but-2-enoate; decanal; (E)-1-(2,6,6-trimethyl-1-cyclohex-3-enyl)but-2-en-1-one; (5E)-3-methylcyclopentadec-5-en-1-one; 4-(2,6,6-trimethyl-1-cyclohex-2-enyl)butan-2-one; 2-methoxy-4-propylphenol; methyl 2-hexyl-3-oxocyclopentane-1-carboxylate; 2,6-dimethyloct-7-en-2-ol; 4,7-dimethyloct-6-en-3-one; 4-(octahydro-4,7-methano-5H-inden-5-yliden)butanal; acetaldehyde ethyl linalyl acetal; ethyl 3,7-dimethyl-2,6-octadienoate; ethyl 2,6,6-trimethylcyclohexa-1,3-diene-1-carboxylate; 2-ethylhexanoate; (6E)-3,7-dimethylnona-1,6-dien-3-ol; ethyl 2-methylbutanoate; ethyl 2-methylpentanoate; ethyl tetradecanoate; ethyl nonanoate; ethyl 3-phenyloxirane-2-carboxylate; 1,4-dioxacycloheptadecane-5,17-dione; 1,3,3-trimethyl-2-oxabicyclo[2,2,2]octane; [essential oil]; oxacyclo-hexadecan-2-one; 3-(4-ethylphenyl)-2,2-dimethylpropanal; 2-butan-2-ylcyclohexan-1-one; 1,4-cyclohexandicarboxylic acid, diethyl ester; (3aalpha,4beta,7beta,7aalpha)-octahydro-4,7-methano-3aH-indene-3a-carboxylic acid ethyl ester; hexahydro-4-7, menthano-1H-inden-6-yl propionate; 2-butenon-1-one,1-(2,6-dimethyl-6-methylencyclohexyl)-; (E)-4-(2,2-dimethyl-6-methylidenecyclohexyl)but-3-en-2-one; 1-methyl-4-propan-2-ylcyclohexa-1,4-diene; 5-heptyloxolan-2-one; 3,7-dimethylocta-2,6-dien-1-ol; [(2E)-3,7-dimethylocta-2,6-dienyl]acetate; [(2E)-3,7-dimethylocta-2,6-dienyl]octanoate; ethyl 2-ethyl-6,6-dimethylcyclohex-2-ene-1-carboxylate; (4-methyl-1-propan-2-yl-1-cyclohex-2-enyl)acetate; 2-butyl-4,6-dimethyl-5,6-dihydro-2H-pyran; oxacyclohexadecen-2-one; 1-propanol,2-[1-(3,3-dimethyl-cyclohexyl)ethoxy]-2-methyl-propanoate; 1-heptyl acetate; 1-hexyl acetate; hexyl 2-methylpropanoate; (2-(1-ethoxyethoxy)ethyl)benzene; 4,4a,5,9b-tetrahydroindeno[1,2-d][1,3]dioxine; undec-10-enal; 3-methyl-4-(2,6,6-trimethyl-2-cyclohexen-1-yl)-3-buten-2-one; 1-(1,2,3,4,5,6,7,8-octahydro-2,3,8,8-tetramethyl-2-naphthalenyl)-ethan-1-one; 7-acetyl,1,2,3,4,5,6,7-octahydro-1,1,6,7,-tetra methyl naphthalene; 3-methylbutyl 2-hydroxybenzoate; [(1R,4S,6R)-1,7,7-trimethyl-6-bicyclo[2.2.1]heptanyl]acetate; [(1R,4R,6R)-1,7,7-trimethyl-6-bicyclo[2.2.1]heptanyl]2-methylpropanoate; (1,7,7-trimethyl-5-bicyclo[2.2.1]heptanyl)propanoate; 2-methylpropyl hexanoate; [2-methoxy-4-[(E)-prop-1-enyl]phenyl]acetate; 2-hexylcyclopent-2-en-1-one; 5-methyl-2-propan-2-ylcyclohexan-1-one; 7-methyloctyl acetate; propan-2-yl 2-methylbutanoate; 3,4,5,6,6-pentamethylheptenone-2; hexahydro-3,6-dimethyl-2(3H)-benzofuranone; 2,4,4,7-tetramethyl-6,8-nonadiene-3-one oxime; dodecyl acetate; [essential oil]; 3,7-dimethylnona-2,6-dienenitrile; [(Z)-hex-3-enyl]methyl carbonate; 2-methyl-3-(4-tert-butylphenyl)propanal; 3,7-dimethylocta-1,6-dien-3-ol; 3,7-dimethylocta-1,6-dien-3-yl acetate; 3,7-dimethylocta-1,6-dien-3-yl butanoate; 3,7-dimethylocta-1,6-dien-3-yl formate; 3,7-dimethylocta-1,6-dien-3-yl 2-methylpropanoate; 3,7-dimethylocta-1,6-dien-3-ylpropanoate; 3-methyl-7-propan-2-ylbicyclo[2.2.2]oct-2-ene-5-carbaldehyde; 2,2-dimethyl-3-(3-methylphenyl)propan-1-ol; 3-(4-tert-butylphenyl)butanal; 2,6-dimethylhept-5-enal; 5-methyl-2-propan-2-yl-cyclohexan-1-ol; 1-(2,6,6-trimethyl-1-cyclohexenyl)pent-1-en-3-one; methyl 3-oxo-2-pentylcyclopentaneacetate; methyl tetradecanoate; 2-methylundecanal; 2-methyldecanal; 1,1-dimethoxy-2,2,5-trimethyl-4-hexene; [(1S)-3-(4-methylpent-3-enyl)-1-cyclohex-3-enyl]methyl acetate; 2-(2-(4-methyl-3-cyclohexen-1-yl)propyl)cyclo-pentanone; 4-penten-1-one, 1-(5,5-dimethyl-1-cyclohexen-1-yl; 1H-indene-ar-propana1,2,3,-dihydro-1,1-dimethyl-(9CI); 2-ethoxynaphthalene; nonanal; 2-(7,7-dimethyl-4-bicyclo[3.1.1]hept-3-enyl)ethyl acetate; octanal; 4-(1-methoxy-1-methylethyl)-1-methylcyclohexene; (2-tert-butylcyclohexyl)acetate; (E)-1-ethoxy-4-(2-methylbutan-2-yl)cyclohexane; 1,1-dimethoxynon-2-yne; [essential oil]; 2-cyclohexylidene-2-phenylacetonitrile; 2-cyclohexyl-1,6-heptadien-3-one; 4-cyclohexyl-2-methylbutan-2-ol; 2-phenylethyl 2-phenylacetate; (2E, 5E/Z)-5,6,7-trimethyl octa-2,5-dien-4-one; 1-methyl-3-(4-methylpent-3-enyl)cyclohex-3-ene-1-carbaldehyde; methyl 2,2-dimethyl-6-methylidenecyclohexane-1-carboxylate; 1-(3,3-dimethylcyclohexyl)ethyl acetate; 4-methyl-2-(2-methylprop-1-enyl)oxane; 1-spiro(4.5)-7-decen-7-yl-4-penten-1-one; 4-(2-butenylidene)-3,5,5-trimethylcyclohex-2-en-1-one; 2-(4-methyl-1-cyclohex-3-enyl)propan-2-ol; 4-isopropylidene-1-methyl-cyclohexene; 2-(4-methyl-1-cyclohex-3-enyl)propan-2-yl acetate; 3,7-dimethyloctan-3-ol; 3,7-dimethyloctan-3-ol; 3,7-dimethyloctan-3-yl acetate; 3-phenylbutanal; (2,5-dimethyl-4-oxofuran-3-yl)acetate; 4-methyl-3-decen-5-ol; undec-10-enal; (4-formyl-2-methoxyphenyl) 2-methylpropanoate; 2,2,5-trimethyl-5-pentylcyclopentan-1-one; 2-tert-butylcyclohexan-1-ol; (2-tert-butylcyclohexyl)acetate; 4-tert-butylcyclohexyl acetate; 1-(3-methyl-7-propan-2-yl-6-bicyclo[2.2.2]oct-3-enyl)ethanone; (4,8-dimethyl-2-propan-2-ylidene-3,3a,4,5,6,8a-hexahydro-1H-azulen-6-yl)acetate; [(4Z)-1-cyclooct-4-enyl]methyl carbonate; methyl beta naphtyl ether; materials and stereoisomers thereof; and a consumer product adjunct ingredient.

2. A consumer product according to claim 1 wherein said benefit agent delivery particle's core material comprises one or more Table 1 materials and/or stereoisomers thereof selected from the group consisting of (5-methyl-2-propan-2-ylcyclohexyl)acetate; 3,7-dimethyloct-6-en-1-al; prop-2-enyl 2-(3-methylbutoxy)acetate; 3-methyl-1-isobutylbutyl acetate; 6,6,9a-trimethyl-1,2,3a,4,5,5a,7,8,9,9b-decahydronaphtho[2,1-b]furan; 7,7-dimethyl-2-methylidene-norbornane; 4-ethoxy-4,8,8-trimethyl-9-methylidenebicyclo[3.3.1]nonane; 2-oxabicyclo2.2.2octane,1methyl4(2,2,3trimethylcyclopentyl); [(Z)-hex-3-enyl]acetate; [(Z)-hex-3-enyl]2-methylbutanoate; 2-(3,7-dimethyloct-6-enoxy)acetaldehyde; 2,4-dimethylcyclohex-3-ene-1-carbaldehyde; 2-cyclohexylethyl acetate; 2-pentylcyclopentan-1-ol; 1-cyclohexylethyl (E)-but-2-enoate; 4-(2,6,6-trimethyl-1-cyclohex-2-enyl)butan-2-one; methyl 2-hexyl-3-oxocyclopentane-1-carboxylate; 4,7-dimethyloct-6-en-3-one; 4-(octahydro-4,7-methano-5H-inden-5-yliden)butanal; acetaldehyde ethyl linalyl acetal; ethyl 3,7-dimethyl-2,6-octadienoate; ethyl 2,6,6-trimethylcyclohexa-1,3-diene-1-carboxylate; 2-ethylhexanoate; ethyl tetradecanoate; ethyl nonanoate; ethyl 3-phenyloxirane-2-carboxylate; 1,4-dioxacycloheptadecane-5,17-dione; [essential oil]; 2-butan-2-ylcyclohexan-1-one; 1,4-cyclohexandicarboxylic acid, diethyl ester; (3aalpha,4beta,7beta,7aalpha)-octahydro-4,7-methano-3aH-indene-3a-carboxylic acid ethyl ester; 2-butenon-1-one,1-(2,6-dimethyl-6-methylencyclohexyl)-; (E)-4-(2,2-dimethyl-6-methylidenecyclohexyl)but-3-en-2-one; 1-methyl-4-propan-2-ylcyclohexa-1,4-diene; [(2E)-3,7-dimethylocta-2,6-dienyl]octanoate; ethyl 2-ethyl-6,6-dimethylcyclohex-2-ene-1-carboxylate; (4-methyl-1-propan-2-yl-1-cyclohex-2-enyl)acetate; 2-butyl-4,6-dimethyl-5,6-dihydro-2H-pyran; oxacyclohexadecen-2-one; 1-propanol,2-[1-(3,3-dimethyl-cyclohexyl)ethoxy]-2-methyl-propanoate; 1-heptyl acetate; (2-(1-ethoxyethoxy)ethyl)benzene; 4,4a,5,9b-tetrahydroindeno[1,2-d][1,3]dioxine; undec-10-enal; [(1R,4R,6R)-1,7,7-trimethyl-6-bicyclo[2.2.1]heptanyl]2-methylpropanoate; (1,7,7-trimethyl-5-bicyclo[2.2.1]heptanyl)propanoate; 2-methylpropyl hexanoate; 2-hexylcyclopent-2-en-1-one; 7-methyloctyl acetate; propan-2-yl 2-methylbutanoate; hexahydro-3,6-dimethyl-2(3H)-benzofuranone; 2,4,4,7-tetramethyl-6,8-nonadiene-3-one oxime; dodecyl acetate; [essential oil]; 3,7-dimethylnona-2,6-dienenitrile; [(Z)-hex-3-enyl]methyl carbonate; 3,7-dimethylocta-1,6-dien-3-ylbutanoate; 3,7-dimethylocta-1,6-dien-3-yl formate; 3,7-dimethylocta-1,6-dien-3-yl 2-methylpropanoate; 3,7-dimethylocta-1,6-dien-3-ylpropanoate; 2,2-dimethyl-3-(3-methylphenyl)propan-1-ol; 3-(4-tert-butylphenyl)butanal; 1-(2,6,6-trimethyl-1-cyclohexenyl)pent-1-en-3-one; methyl tetradecanoate; 2-methyldecanal; 1,1-dimethoxy-2,2,5-trimethyl-4-hexene; [(1S)-3-(4-methylpent-3-enyl)-1-cyclohex-3-enyl]methyl acetate; 2-(2-(4-methyl-3-cyclohexen-1-yl)propyl)cyclo-pentanone; 4-penten-1-one, 1-(5,5-dimethyl-1-cyclohexen-1-yl; 1H-indene-ar-propana1,2,3,-dihydro-1,1-dimethyl-(9CI); 2-ethoxynaphthalene; 2-(7,7-dimethyl-4-bicyclo[3.1.1]hept-3-enyl)ethyl acetate; 4-(1-methoxy-1-methylethyl)-1-methylcyclohexene; (E)-1-ethoxy-4-(2-methylbutan-2-yl)cyclohexane; 1,1-dimethoxynon-2-yne; 2-cyclohexyl-1,6-heptadien-3-one; 4-cyclohexyl-2-methylbutan-2-ol; (2E, 5E/Z)-5,6,7-trimethyl octa-2,5-dien-4-one; 1-methyl-3-(4-methylpent-3-enyl)cyclohex-3-ene-1-carbaldehyde; methyl 2,2-dimethyl-6-methylidenecyclohexane-1-carboxylate; 1-(3,3-dimethylcyclohexyl)ethyl acetate; 4-(2-butenylidene)-3,5,5-trimethylcyclohex-2-en-1-one; 4-isopropylidene-1-methyl-cyclohexene; 3,7-dimethyloctan-3-yl acetate; 3-phenylbutanal; (4-formyl-2-methoxyphenyl) 2-methylpropanoate; 2-tert-butylcyclohexan-1-ol; 1-(3-methyl-7-propan-2-yl-6-bicyclo[2.2.2]oct-3-enyl)ethanone; (4,8-dimethyl-2-propan-2-ylidene-3,3a,4,5,6,8a-hexahydro-1H-azulen-6-yl)acetate; [(4Z)-1-cyclooct-4-enyl]methyl carbonate; said materials when present being present, based total core weight, at the level of from about 0.1% to about 80%, 0.1% to about 50% or 0.1% to about 30%.

3. A consumer product according to claim 1, wherein:
a) at least 75% of said benefit agent delivery particles having a fracture strength of from about 0.2 MPa to about 10 MPa; preferably from about 0.4 MPa to about 5 MPa, more preferably from about 0.6 MPa to about 3.5 MPa, most preferably from about 0.7 MPa to about 3 MPa
b) said benefit agent delivery particles having a benefit agent leakage of from about 0% to about 30%, preferably from about 0% to about 20%, more preferably from about 0% to about 5%; and
c) said benefit agent delivery particles' having a headspace ratio of from about 2 to about 10,000; from about 3 to about 1,000; or even from about 5 to about 1,000.

4. A consumer product according to claim 1 comprising:
a) benefit agent delivery particles comprising a core material, selected from the group consisting of (5-methyl-2-propan-2-ylcyclohexyl)acetate; 3,7-dimethyloct-6-en-1-al; prop-2-enyl 2-(3-methylbutoxy)acetate; 3-methyl-1-isobutylbutyl acetate; 6,6,9a-trimethyl-1,2,3a,4,5,5a,7,8,9,9b-decahydronaphtho[2,1-b]furan; 7,7-dimethyl-2-methylidene-norbornane; 4-ethoxy-4,8,8-trimethyl-9-methylidenebicyclo[3.3.1]nonane; 2-oxabicyclo2.2.2octane,1methyl4(2,2,3trimethylcyclopentyl); [(Z)-hex-3-enyl]acetate; [(Z)-hex-3-enyl]2-methylbutanoate; 2-(3,7-dimethyloct-6-enoxy)acetaldehyde; 2,4-dimethylcyclohex-3-ene-1-carbaldehyde; 2-cyclohexylethyl acetate; 2-pentylcyclopentan-1-ol; 1-cyclohexylethyl (E)-but-2-enoate; 4-(2,6,6-trimethyl-1-cyclohex-2-enyl)butan-2-one; methyl 2-hexyl-3-oxocyclopentane-1-carboxylate; 4,7-dimethyloct-6-en-3-one; 4-(octahydro-4,7-methano-5H-inden-5-yliden)butanal; acetaldehyde ethyl linalyl acetal; ethyl 3,7-dimethyl-2,6-octadienoate; ethyl 2,6,6-trimethylcyclohexa-1,3-diene-1-carboxylate; 2-ethylhexanoate; ethyl tetradecanoate; ethyl nonanoate; ethyl 3-phenyloxirane-2-carboxylate; 1,4-dioxacycloheptadecane-5,17-dione; [essential oil]; 2-butan-2-ylcyclohexan-1-one; 1,4-cyclohexandicarboxylic acid, diethyl ester; (3aalpha,4beta,7beta,7aalpha)-octahydro-4,7-methano-3aH-indene-3a-carboxylic acid ethyl ester; 2-butenon-1-one,1-(2,6-dimethyl-6-methylencyclohexyl)-; (E)-4-(2,2-dimethyl-6-methylidenecyclohexyl)but-3-en-2-one; 1-methyl-4-propan-2-ylcyclohexa-1,4-diene; [(2E)-3,7-dimethylocta-2,6-dienyl]octanoate; ethyl 2-ethyl-6,6-dimethylcyclohex-2-ene-1-carboxylate; (4-methyl-1-propan-2-yl-1-cyclohex-2-enyl)acetate; 2-butyl-4,6-dimethyl-5,6-dihydro-2H-pyran; oxacyclohexadecen-2-one; 1-propanol,2-[1-(3,3-dimethyl-cyclohexyl)ethoxy]-2-methyl-propanoate; 1-heptyl acetate; (2-(1-ethoxyethoxy)ethyl)benzene; 4,4a,5,9b-tetrahydroindeno[1,2-d][1,3]dioxine; undec-10-enal; [(1R,4R,6R)-1,7,7-trimethyl-6-bicyclo[2.2.1]heptanyl]2-methylpropanoate; (1,7,7-trimethyl-5-bicyclo[2.2.1]heptanyl)propanoate; 2-methylpropyl hexanoate; 2-hexylcyclopent-2-en-1-one; 7-methyloctyl acetate; propan-2-yl 2-methylbutanoate; hexahydro-3,6-dimethyl-2(3H)-benzofuranone; 2,4,4,7-tetramethyl-6,8-nonadiene-3-one oxime; dodecyl acetate; [essential oil]; 3,7-dimethylnona-2,6-dienenitrile; [(Z)-hex-3-enyl]methyl carbonate; 3,7-dimethylocta-1,6-dien-3-yl butanoate; 3,7-dimethylocta-1,6-dien-3-yl formate; 3,7-dimethylocta-1,6-dien-3-yl 2-methylpropanoate; 3,7-dimethylocta-1,6-dien-3-yl propanoate; 2,2-dimethyl-3-(3-methylphenyl)propan-1-ol; 3-(4-tert-butylphenyl)butanal; 1-(2,6,6-trimethyl-1-cyclohexenyl)pent-1-en-3-one; methyl tetradecanoate; 2-methyldecanal; 1,1-dimethoxy-2,2,5-trimethyl-4-hexene; [(1S)-3-(4-methylpent-3-enyl)-1-cyclohex-3-enyl]methyl acetate; 2-(2-(4-methyl-3-cyclohexen-1-yl)propyl)cyclo-pentanone; 4-penten-1-one, 1-(5,5-dimethyl-1-cyclohexen-1-yl; 1H-indene-ar-propana1,2,3,-dihydro-1,1-dimethyl-(9CI); 2-ethoxynaphthalene; 2-(7,7-dimethyl-4-bicyclo[3.1.1]hept-3-enyl)ethyl acetate; 4-(1-methoxy-1-methylethyl)-1-methylcyclohexene; (E)-1-ethoxy-4-(2-methylbutan-2-yl)cyclohexane; 1,1-dimethoxynon-2-yne; 2-cyclohexyl-1,6-heptadien-3-one; 4-cyclohexyl-2-methylbutan-2-ol; (2E, 5E/Z)-5,6,7-trimethyl octa-2,5-dien-4-one; 1-methyl-3-(4-methylpent-3-enyl)cyclohex-3-ene-1-carbaldehyde; methyl 2,2-dimethyl-6-methylidenecyclohexane-1-carboxylate; 1-(3,3-dimethylcyclohexyl)ethyl acetate; 4-(2-butenylidene)-3,5,5-trimethylcyclohex-2-en-1-one; 4-isopropylidene-1-methyl-cyclohexene; 3,7-dimethyloctan-3-yl acetate; 3-phenylbutanal; (4-formyl-2-methoxyphenyl) 2-methylpropanoate; 2-tert-butylcyclohexan-1-ol; 1-(3-methyl-7-propan-2-yl-6-bicyclo[2.2.2]oct-3-enyl)ethanone; (4,8-dimethyl-2-propan-2-ylidene-3,3a,4,5,6,8a-hexahydro-1H-azulen-6-yl)acetate; [(4Z)-1-cyclooct-4-enyl]methyl carbonate; stereoisomers of such Table 1 materials, and mixtures thereof and a shell, said shell encapsulating said core material, preferably said shell comprises a resin selected from the group consisting of a reaction product of an aldehyde, preferably formaldehyde, with an amine, preferably said amine being selected from the group consisting of melamine, urea, benzoguanamine, glycoluril, and mixtures thereof:
ii. at least 75%, preferably at least 85%, more preferably at least 90% of said benefit agent delivery particles having a fracture strength of from 0.2 MPa to 10 MPa, preferably from 0.4 MPa to 5 MPa, more preferably from 0.6 MPa to 3.5 MPa, most preferably from 0.7 MPa to 3 MPa; and
iii. said particles having a benefit agent leakage of from 0% to 30%, preferably from 0% to 20%, more preferably from 0% to 5%; and
b) a consumer product adjunct material, preferably said adjunct material comprises a structurant, said structurant comprising a material selected from the group consisting of polysaccharides, modified celluloses, modified proteins, inorganic salts, quaternized polymeric materials, imidazoles; nonionic polymers having a pKa less than 6.0, polyurethanes, and mixtures thereof; and
c) preferably a formaldehyde scavenger.

5. The consumer product of claim 4, wherein at least 75%, preferably at least 85%, more preferably at least 90% of said benefit agent delivery particles have a particle size of from 1 microns to 80 microns, preferably 5 microns to 60 microns, more preferably from 6 microns to 40 microns, most preferably from 10 microns to 35 microns.

6. The consumer product of claim 4 or 5, wherein at least 75%, preferably at least 85%, more preferably at least 90% of said benefit agent delivery particles have a particle wall thickness of from 40 nm to 250 nm, preferably from 50 nm to 180 nm, most preferably from 60 nm to 160 nm.

7. The consumer product of claims 4 to 6 wherein said benefit agent delivery particles comprise, based on total benefit agent delivery particle weight, at least 1 weight %, from 20 to 95 weight %, from 50 to 90 weight %, or even from 80 to 85 weight % of a benefit agent.

8. The consumer product of claims 4 to 7 wherein said benefit agent delivery particles' core material comprises, based on total core material weight, at least 20, from 50 to 70, or even from 60 to 100 wt % benefit agent.

9. The consumer product of claims 4 to 8 wherein said benefit agent comprises a perfume composition, said particles comprising, based on total particle weight, from 20 weight % to 95 weight %, from 50 weight % to 90 weight %, from 70 weight % to 85 weight %, or even from 80 weight % to 85 weight % of said perfume composition.

10. The consumer product of claims 4 to 9, said consumer product comprising a material selected from the group consisting of a formaldehyde scavenger, a structurant, an anti-agglomeration agent and mixtures thereof.

11. The consumer product of claims 4 to 10, comprising from 0.001% to 25%, from 0.001% to 10%, or from 0.01% to 3%, based on total consumer product mass weight of said benefit agent delivery particles.

12. A method of treating and/or cleaning a situs, said method comprising
a) optionally washing and/or rinsing said situs;
b) contacting said situs with a consumer product according to claims 1 to 10; and
c) optionally washing and/or rinsing said situs.

13. A situs treated with a consumer product according to any one of claims 1 through 10.

14. A process of making a consumer product according to any one of claims 4 through 10 comprising combining a consumer adjunct material and a benefit agent delivery particle produced by the process of:
a.) preparing a first solution comprising, based on total solution weight from 20% to 90%, from 40% to 80%, or even from 60% to 80% water, a first emulsifier and a first resin, the ratio of said first emulsifier and said first resin being from 0.1:1 to 10:1, from 0.5:1 to 3:1, or even from 0.8:1 to 1.1:1;
b.) preparing a second solution comprising based on total solution weight from 20% to 95% water, a second emulsifier and a second resin, the ratio of said second emulsifier and said second resin being from 0:1 to 3:1, from 0.04:1 to 0.2:1, or even from 0.05:1 to 0.15:1;
c.) combining a core material comprising a material selected from the group consisting of (5-methyl-2-propan-2-ylcyclohexyl)acetate; 3,7-dimethyloct-6-en-1-al; prop-2-enyl 2-(3-methylbutoxy)acetate; 3-methyl-1-isobutylbutyl acetate; 6,6,9a-trimethyl-1,2,3a,4,5,5a,7,8,9,9b-decahydronaphtho[2,1-b]furan; 7,7-dimethyl-2-methylidene-norbornane; 4-ethoxy-4,8,8-trimethyl-9-methylidenebicyclo[3.3.1]nonane; 2-oxabicyclo2.2.2octane,1methyl4(2,2,3trimethylcyclopentyl); [(Z)-hex-3-enyl]acetate; [(Z)-hex-3-enyl]2-methylbutanoate; 2-(3,7-dimethyloct-6-enoxy)acetaldehyde; 2,4-dimethylcyclohex-3-ene-1-carbaldehyde; 2-cyclohexylethyl acetate; 2-pentylcyclopentan-1-ol; 1-cyclohexylethyl (E)-but-2-enoate; 4-(2,6,6-trimethyl-1-cyclohex-2-enyl)butan-2-one; methyl 2-hexyl-3-oxocyclopentane-1-carboxylate; 4,7-dimethyloct-6-en-3-one; 4-(octahydro-4,7-methano-5H-inden-5-yliden)butanal; acetaldehyde ethyl linalyl acetal; ethyl 3,7-dimethyl-2,6-octadienoate; ethyl 2,6,6-trimethylcyclohexa-1,3-diene-1-carboxylate; 2-ethylhexanoate; ethyl tetradecanoate; ethyl nonanoate; ethyl 3-phenyloxirane-2-carboxylate; 1,4-dioxacycloheptadecane-5,17-dione; [essential oil]; 2-butan-2-ylcyclohexan-1-one; 1,4-cyclohexandicarboxylic acid, diethyl ester; (3aalpha,4beta,7beta,7aalpha)-octahydro-4,7-methano-3aH-indene-3a-carboxylic acid ethyl ester; 2-butenon-1-one,1-(2,6-dimethyl-6-methylencyclohexyl)-; (E)-4-(2,2-dimethyl-6-methylidenecyclohexyl)but-3-en-2-one; 1-methyl-4-propan-2-ylcyclohexa-1,4-diene; [(2E)-3,7-dimethylocta-2,6-dienyl]octanoate; ethyl 2-ethyl-6,6-dimethylcyclohex-2-ene-1-carboxylate; (4-methyl-1-propan-2-yl-1-cyclohex-2-enyl)acetate; 2-butyl-4,6-dimethyl-5,6-dihydro-2H-pyran; oxacyclohexadecen-2-one; 1-propanol,2-[1-(3,3-dimethyl-cyclohexyl)ethoxy]-2-methyl-propanoate; 1-heptyl acetate; (2-(1-ethoxyethoxy)ethyl)benzene; 4,4a,5,9b-tetrahydroindeno[1,2-d][1,3]dioxine; undec-10-enal; [(1R,4R,6R)-1,7,7-trimethyl-6-bicyclo[2.2.1]heptanyl]2-methylpropanoate; (1,7,7-trimethyl-5-bicyclo[2.2.1]heptanyl)propanoate; 2-methylpropyl hexanoate; 2-hexylcyclopent-2-en-1-one; 7-methyloctyl acetate; propan-2-yl 2-methylbutanoate; hexahydro-3,6-dimethyl-2(3H)-benzofuranone; 2,4,4,7-tetramethyl-6,8-nonadiene-3-one oxime; dodecyl acetate; [essential oil]; 3,7-dimethylnona-2,6-dienenitrile; [(Z)-hex-3-enyl]methyl carbonate; 3,7-dimethylocta-1,6-dien-3-yl butanoate; 3,7-dimethylocta-1,6-dien-3-yl formate; 3,7-dimethylocta-1,6-dien-3-yl 2-methylpropanoate; 3,7-dimethylocta-1,6-dien-3-yl propanoate; 2,2-dimethyl-3-(3-methylphenyl)propan-1-ol; 3-(4-tert-butylphenyl)butanal; 1-(2,6,6-trimethyl-1-cyclohexenyl)pent-1-en-3-one; methyl tetradecanoate; 2-methyldecanal; 1,1-dimethoxy-2,2,5-trimethyl-4-hexene; [(1S)-3-(4-methylpent-3-enyl)-1-cyclohex-3-enyl]methyl acetate; 2-(2-(4-methyl-3-cyclohexen-1-yl)propyl)cyclo-pentanone; 4-penten-1-one, 1-(5,5-dimethyl-1-cyclohexen-1-yl; 1H-indene-ar-propana1,2,3,-dihydro-1,1-dimethyl-(9CI); 2-ethoxynaphthalene; 2-(7,7-dimethyl-4-bicyclo[3.1.1]hept-3-enyl)ethyl acetate; 4-(1-methoxy-1-methylethyl)-1-methylcyclohexene; (E)-1-ethoxy-4-(2-methylbutan-2-yl)cyclohexane; 1,1-dimethoxynon-2-yne; 2-cyclohexyl-1,6-heptadien-3-one; 4-cyclohexyl-2-methylbutan-2-ol; (2E, 5E/Z)-5,6,7-trimethyl octa-2,5-dien-4-one; 1-methyl-3-(4-methylpent-3-enyl)cyclohex-3-ene-1-carbaldehyde; methyl 2,2-dimethyl-6-methylidenecyclohexane-1-carboxylate; 1-(3,3-dimethylcyclohexyl)ethyl acetate; 4-(2-butenylidene)-3,5,5-trimethylcyclohex-2-en-1-one; 4-isopropylidene-1-methyl-cyclohexene; 3,7-dimethyloctan-3-yl acetate; 3-phenylbutanal; (4-formyl-2-methoxyphenyl) 2-methylpropanoate; 2-tert-butylcyclohexan-1-ol; 1-(3-methyl-7-propan-2-yl-6-bicyclo[2.2.2]oct-3-enyl)ethanone; (4,8-dimethyl-2-propan-2-ylidene-3,3a,4,5,6,8a-hexahydro-1H-azulen-6-yl)acetate; [(4Z)-1-cyclooct-4-enyl]methyl carbonate; stereoisomers of such Table 1 materials and mixtures thereof and said first solution to form a first composition;
d.) emulsifying said first composition;
e.) combining said first composition and said second solution to form a second composition and optionally combining any processing aids and said second composition;
f.) mixing said second composition for at least 15 minutes, at least 1 hour or even from 4 hours to 100 hours at a temperature of from 25° C. to 100° C., from 45° C. to 90° C., or even from 60° C. to 85° C. heat and optionally combining any processing aids to said second composition;
g.) optionally combining any scavenger material, structurant, and/or anti-agglomeration agent with said second composition during step f.) or thereafter
h.) optionally spray drying said second composition.

15. A consumer product produced according to the process of claim 14, wherein said emulsifier comprises a moiety selected from the group consisting of carboxy, hydroxyl, thiol, amine, amide and combinations thereof, said emulsifier having a pKa of less than 5, preferably greater than 0 but less than 5.

16. A consumer product produced according to the process of claim 14 or 15 wherein in any of the process steps, the pH of the first and second solutions is controlled such that the pH of said first and second solution is from about 3 to about 7; from about 4.5 to about 7; or from about 5 to about 6.5.

17. A consumer product produced according to the process of claims 14 through 16 wherein in step f.), from 0% to 10%, from 1% to 5% or even from 2% to 4%, based on total second composition weight, of a salt comprising an anion and cation, said anion being selected from the group consisting of chloride, sulfate, phosphate, nitrate, polyphosphate, citrate, maleate, fumarate and mixtures thereof; and said cation being selected from the group consisting of a Periodic Group IA element, Periodic Group IIA element, ammonium cation and mixtures thereof, preferably sodium sulfate, is combined with said second composition.
